(19) United States
(12) Patent Application Publication
(10) Pub. No.: US 2003/0175518 A1
(43) Pub. Date: Sep. 18, 2003

(54) Magnetic composite particles for magnetic color toner, magnetic color toner using the same, method for developing magnetic latent image using the toner, and method for developing electrostatic image using the toner

(76) Inventors: Seiji Ishitani, Hiroshima-shi (JP); Keisuke Iwasaki, Hiroshima-shi (JP); Hiroko Morii, Hiroshima-shi (JP); Kazuyuki Hayashi, Hiroshima-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/328,185

(22) Filed: Dec. 26, 2002

(30) Foreign Application Priority Data
Dec. 28, 2001 (JP) 2001-401673

(51) Int. Cl. B32B 17/02

(52) U.S. Cl. 428/403; 428/570; 428/900

(57) ABSTRACT

Magnetic color toner comprising: a binder resin, a colorant and magnetic composite particles having an average particle diameter of 0.06 to 10.0 μm, comprising:

magnetic particles as core particles,

a gluing agent coating layer formed on surface of said magnetic particles, and

an organic yellow-based pigment coat, an organic red-based pigment coat or an organic blue-based pigment coat formed on said gluing agent coating layer in an amount of from 1 to 200 parts by weight based on 100 parts by weight of said magnetic particles. The magnetic color toner exhibits not only a clear hue but also an excellent light resistance.

### BACKGROUND OF THE INVENTION

The present invention relates to magnetic composite particles for magnetic color toner, a magnetic color toner using the magnetic composite particles, a method for developing a magnetic latent image using the magnetic color toner and a method for developing an electrostatic image using the magnetic color toner. More particularly, the present invention relates to magnetic composite particles for magnetic color toner which are capable of producing such a magnetic color toner exhibiting not only a clear hue but also an excellent light resistance, a magnetic color toner using the magnetic composite particles, a method for developing a magnetic latent image using the magnetic color toner and a method for developing an electrostatic image using the magnetic color toner.

As the recent main developing methods which use a magnetic toner, there are known a one-component developing method which requires no carrier, and a two-component developing method which uses both magnetic toner and carrier. In the two-component developing method, the magnetic toner is brought into frictional contact with the carrier in order to apply an electric charge reverse to that of an electrostatic latent image to the magnetic toner. This causes the magnetic toner to adhere onto the electrostatic latent image by electrostatic attraction force therebetween and to neutralize the electric charge, thereby developing the electrostatic latent image into a visual toner image.

In the developing method which uses the magnetic toner, as magnetic particles for the magnetic toner, there have been generally used magnetite, maghemite, etc. from standpoints of good magnetic properties, low costs and good handling property. These magnetic particles exhibit a brown to black color and, therefore, are suitably used as raw materials for mono-color magnetic toners exhibiting a sepia color or a black color. However, when the magnetic particles are used as a magnetism-imparting agent for magnetic color toners, there arises such a problem that the brown to black color of the magnetic particles themselves adversely affects the hue of the color toners, resulting in formation of only dark images.

Consequently, it has been strongly required to provide magnetic particles capable of not only imparting a good magnetism to the color toners, but also causing the color toners to exhibit their own colors without discoloration due to the hue of the magnetic particles.

Also, in any type of the developing methods, it has been required that the magnetic color toner undergoes less scattering to prevent image fogging, and exhibits a high image density upon fixing as well as a stable image density (high image durability).

Further, it is known that among organic pigments used for the color toners, phthalocyanine-based pigments as organic blue-based pigments have an excellent light resistance. Whereas, organic red-based pigments and organic yellow-based pigments are deteriorated in light resistance. Therefore, it has also been required to improve the light resistance of the organic red-based and yellow-based pigments.

As the magnetic particles for magnetic color toner, there are known magnetic particles whose surface is coated with a colorant through a coupling agent (Japanese Patent Application Laid-Open (KOKAI) No. 60-26954(1985), etc.); magnetic particles having on the surface thereof a coating layer exhibiting a color tone other than black such as white (Japanese Patent Application Laid-Open (KOKAI) Nos. 51-46131(1976), 58-25643(1983) and 11-84720(1999), etc.); or the like.

At present, it has been strongly required to provide magnetic particles for magnetic color toner, which are capable of producing a magnetic color toner having not only a clear hue but also an excellent light resistance. However, the above-described prior arts have failed to obtain magnetic particles for magnetic color toner, which can satisfy these requirements.

That is, in Japanese Patent Application Laid-Open (KOKAI) No. 60-26954(1985), there are described the magnetic particles for toner whose surface is coated with a colorant through a coupling agent. However, since the formation of a colorant coat on the surface of the magnetic particles is conducted by mixing the colorant and the coupling agent with the magnetic particles at the same time, the adhesion strength of the colorant coat onto the surface of the magnetic particles tends to be lowered as shown in the below-mentioned Comparative Examples. Therefore, when such magnetic particles are used to produce a magnetic toner, the colorant tends to be desorbed from the surface of the magnetic particles, so that the hue of the magnetic particles themselves may be exposed to the surface of the obtained magnetic toner. As a result, it may be difficult to obtain a magnetic color toner having a clear hue.

Also, in Japanese Patent Application Laid-Open (KOKAI) No. 11-84720(1999), there are described the magnetic particles whose surface is coated with a silicone-based polymer film. However, when such magnetic particles are used to produce a magnetic toner, although the lightness (whiteness) of the obtained magnetic toner is increased, it may be difficult to satisfactorily improve the hue thereof.

In addition, the ones of inventors have proposed magnetic composite particles having an average particle diameter of 0.06 to 1.0 μm and a coercive force value of less than 39.790 kA/m, comprising:

magnetic core particles,

a coating formed on surface of the magnetic core particles, comprising at least one organosilicon compound selected from the group consisting of:

(1) organosilane compounds obtainable from alkoxysilane compounds, and

(2) polysiloxanes or modified polysiloxanes, and

an organic blue-based pigment coat formed on the coating layer comprising said organosilicon compound, in an amount of from 1 to 50 parts by weight based on 100 parts by weight of the magnetic core particles. (U.S. Pat. No. 6,475,687/EP 1168087 A) . The magnetic composite particles are used for black magnetic toner.

As a result of the present inventors' earnest studies, it has been found that by mixing magnetic particles with a gluing agent to form a gluing agent coating layer on the surface of the magnetic particles, mixing the magnetic particles having thereon the gluing agent coating layer, with organic pigments to form an organic pigment coat on the surface of the gluing agent coating layer, thereby obtaining magnetic composite particles, and then blending the magnetic composite particles with a binder resin and a colorant, the obtained magnetic color toner can exhibit not only a clear hue, but also an excellent light resistance. The present invention has been attained on the basis of this finding.

### SUMMARY OF THE INVENTION

An object of the present invention is to provide magnetic composite particles for magnetic color toner which are capable of producing a magnetic color toner exhibiting not only a clear hue but also an excellent light resistance.

Another object of the present invention is to provide a magnetic color toner having a clear hue and an excellent light resistance.

A further object of the present invention is to provide a method for developing a magnetic latent image, which is capable of forming images having less image fogging, a high image density and an excellent image durability.

A still further object of the present invention is to provide a method for developing an electrostatic image, which is capable of forming images having less image fogging, a high image density and an excellent image durability.

To accomplish the aims, in a first aspect of the present invention, there are provided magnetic composite particles having an average particle diameter of 0.06 to 10.0 μm, comprising:

magnetic particles as core particles,

a gluing agent coating layer formed on surface of said magnetic particles, and

an organic yellow-based pigment coat or an organic red-based pigment coat formed on said gluing agent coating layer in an amount of from 1 to 200 parts by weight based on 100 parts by weight of said magnetic particles.

In a second aspect of the present invention, there are provided magnetic composite particles having an average particle diameter of 0.06 to 10.0 μm, comprising:

magnetic particles as core particles,

a gluing agent coating layer formed on surface of said magnetic particles, and

an organic blue-based pigment coat formed on said coating layer comprising said organosilicon compound, in an amount of from more than 50 to 200 parts by weight based on 100 parts by weight of said magnetic particles.

In a third aspect of the present invention, there is provided magnetic color toner comprising:

a binder resin, a colorant and

magnetic composite particles having an average particle diameter of 0.06 to 10.0 μm, comprising:

magnetic particles as core particles,

a gluing agent coating layer formed on surface of said magnetic particles, and

an organic yellow-based pigment coat, an organic red-based pigment coat or an organic blue-based pigment coat formed on said gluing agent coating layer in an amount of from 1 to 200 parts by weight based on 100 parts by weight of said magnetic particles.

In a fourth aspect of the present invention, there is provided magnetic color toner comprising:

(1) an yellow toner comprising a binder resin, an organic yellow-based pigment as a colorant and

magnetic composite particles having an average particle diameter of 0.06 to 10.0 μm, comprising:

magnetic particles as core particles,

a gluing agent coating layer formed on surface of said magnetic particles, and

an organic yellow-based pigment coat formed on said gluing agent coating layer in an amount of from 1 to 200 parts by weight based on 100 parts by weight of said magnetite particles;

(2) a red toner comprising a binder resin, an organic red-based pigment as a colorant and

magnetic composite particles having an average particle diameter of 0.06 to 10.0 μm, comprising:

magnetic particles as core particles,

a gluing agent coating layer formed on surface of said magnetic particles, and

an organic red-based pigment coat formed on said gluing agent coating layer in an amount of from 1 to 200 parts by weight based on 100 parts by weight of said magnetite particles; and

(3) a blue comprising a binder resin, an organic blue-based pigment as a colorant and

magnetic composite particles having an average particle diameter of 0.06 to 10.0 μm, comprising:

magnetic particles as core particles,

a gluing agent coating layer formed on surface of said magnetic particles, and

an organic blue-based pigment coat formed on said gluing agent coating layer in an amount of from 1 to 200 parts by weight based on 100 parts by weight of said magnetite particles.

In a fifth aspect of the present invention, there is provided a method for developing a magnetic latent image, comprising:

forming a magnetic latent image on surface of an image-retaining member made of a magnetic material;

supplying a developer containing the magnetic toner as defined in the third aspect onto a non-magnetic sleeve disposed opposite to the surface of the image-retaining member made of the magnetic material and provided inside thereof with a magnetic field-generating element to form a magnetic brush on the non-magnetic sleeve; and

bringing the magnetic brush formed on the non-magnetic sleeve into sliding contact with the surface of the image-retaining member to develop the magnetic latent image.

In a sixth aspect of the present invention, there is provided a method for developing an electrostatic image, comprising:

forming an electrostatic image on surface of a photosensitive member or an electrostatic charge-retaining member;

supplying a developer containing a magnetic carrier and the magnetic toner as defined in claim 21 onto a non-magnetic sleeve disposed opposite to the surface of the photosensitive member or the electrostatic charge-retaining member made of the magnetic material and provided inside thereof with a magnetic field-generating element to form a magnetic brush on the non-magnetic sleeve; and

bringing the magnetic brush formed on the non-magnetic sleeve into sliding contact with the surface of the photosensitive member or the electrostatic charge-retaining member to develop the electrostatic image.

In a seventh aspect of the present invention, there are provided magnetic composite particles having an average particle diameter of 0.06 to 10.0 μm and a geometrical standard deviation of particle size of 1.01 to 2.5, comprising:

magnetic particles as core particles, having a coat formed on at least a part of the surface of said magnetic particles as core particles, comprising at least one compound selected from the group consisting of hydroxides of aluminum, oxides of aluminum, hydroxides of silicon and oxides of silicon in an amount of 0.01 to 20% by weight, calculated as Al or SiO₂, based on the total weight of the magnetic particles coated

a gluing agent coating layer formed on surface of said magnetic particles, and

an organic yellow-based pigment coat or an organic red-based pigment coat formed on said gluing agent coating layer in an amount of from 1 to 200 parts by weight based on 100 parts by weight of said magnetic particles.

In an eighth aspect of the present invention, there are provided magnetic composite particles having an average particle diameter of 0.06 to 10.0 μm and a geometrical standard deviation of particle size of 1.01 to 2.5, comprising:

magnetic particles as core particles, having a coat formed on at least a part of the surface of said magnetic particles as core particles, comprising at least one compound selected from the group consisting of hydroxides of aluminum, oxides of aluminum, hydroxides of silicon and oxides of silicon in an amount of 0.01 to 20% by weight, calculated as Al or SiO₂, based on the total weight of the magnetic particles coated

a gluing agent coating layer formed on surface of said magnetic particles, and

an organic blue-based pigment coat formed on said coating layer comprising said organosilicon compound, in an amount of from more than 50 to 200 parts by weight based on 100 parts by weight of said magnetic particles.

### DETAILED DESCRIPTION OF THE INVENTION

The present invention is described in detail below.

First, the magnetic composite particles for magnetic color toner according to the present invention are described.

The magnetic composite particles for magnetic color toner according to the present invention comprises magnetic particles as core particles, a gluing agent coating layer formed on the surface of the magnetic particles, and an organic pigment coat formed on the gluing agent coating layer.

Examples of the magnetic particles as core particles used in the present invention may include spinel-type iron oxide particles such as magnetite particles, maghemite particles and Mn—Zn ferrite particles, magnetic metal particles containing iron as a main component, magnetic iron alloy particles containing metal elements other than iron such as Co, Al, Ni, P, Zn, Si, B and rare earth metals, iron carbonyl and garnet-type iron oxide particles, magnetoplumbite-type iron oxide particles such as Ba ferrite particles and Sr ferrite particles, or the like. Among these magnetic particles, in the consideration of magnetic properties and economical efficiency, preferred are spinel-type iron oxide particles and magnetic metal particles containing iron as a main component, and more preferred are spinel-type iron oxide particles.

The magnetic particles as core particles used in the present invention may have any suitable shape, and may be either isotropic particles such as spherical particles, granular particles, hexahedral particles, octahedral particles and polyhedral particles, or anisotropic particles such as acicular particles, spindle-shaped particles and rice ball-shaped particles.

As to the particle size of the magnetic particles as core particles used in the present invention, the average particle diameter of the magnetic particles (average major axis diameter in the case of anisotropic particles) is usually 0.06 to 10.0 μm. When the average particle diameter is less than 0.06 μm, the particles tend to be agglomerated by the increase of intermolecular force therebetween due to fine particles, so that it may be difficult to form a uniform gluing agent coating layer on the surface of the magnetic particles and to uniformly adhere the organic pigments onto the gluing agent coating layer. When the average particle diameter is more than 10.0 μm, the magnetic composite particles obtained using the magnetic particles have a too large particle size substantially identical to that of the magnetic color toner.

Also, the magnetic particles as core particles used in the present invention preferably have a hiding power as low as possible. Therefore, the average particle diameter of the magnetic particles is preferably out of the range near 0.3 μm at which the light scattering coefficient is highest and, therefore, the hiding power becomes maximum. That is, the average particle diameter thereof is preferably from 0.06 to 0.25 μm or from 0.35 to 7.5 μm, more preferably from 0.06 to 0.2 μm or from 0.4 to 5.0 μm.

The magnetic particles as core particles used in the present invention have a geometrical standard deviation of particle diameter (major axis diameter in the case of anisotropic particles) of usually not more than 2.5, preferably not more than 2.4, more preferably not more than 2.3. When the geometrical standard deviation is more than 2.5, coarse particles are present in the obtained magnetic particles, thereby inhibiting the magnetic particles from being uniformly dispersed. As a result, it may be difficult to form a uniform gluing agent coating layer on the surface of the magnetic particles and to uniformly adhere the organic pigments onto the gluing agent coating layer. The lower limit value of the geometrical standard deviation is 1.01 because the particles having a geometrical standard deviation of less than 1.01 are difficult to produce industrially.

The magnetic particles as core particles used in the present invention have a BET specific surface area value of usually 0.5 to 100 m²/g, preferably 1.0 to 95 m²/g, more preferably 1.5 to 90 m²/g. When the BET specific surface area value is more than 100 m²/g, the particles tend to be agglomerated by the increase of intermolecular force therebetween due to fine particles, so that it may be difficult to form a uniform gluing agent coating layer on the surface of the magnetic particles and to uniformly adhere the organic pigments onto the gluing agent coating layer.

The magnetic particles as core particles used in the present invention have a hiding power of usually not more than 4,500 cm²/g, preferably not more than 4,000 cm²/g, more preferably not more than 3,500 cm²/g. When the hiding power is more than 4,500 cm²/g, the hue of the magnetic particles themselves is too strong, so that even though the organic pigments are adhered onto the surface of the magnetic particles through the gluing agent, the obtained magnetic composite particles may fail to exhibit a clear hue of the organic pigments due to adverse influence by such a strong hue of the magnetic particles. As a result, the magnetic color toner obtained from such magnetic composite particles may also fail to exhibit a clear hue.

As to the hue of the magnetic particles as core particles used in the present invention, the lower limit of the L* value thereof is usually 18.0, preferably 19.0, and the upper limit of the L* value thereof is usually about 35.0. When the L* value is less than 18.0, the particles exhibit a too high blackness, so that even though the organic pigments are adhered onto the surface of the magnetic particles, it may be difficult to increase a chroma of the obtained particles.

As to the magnetic properties of the magnetic particles as core particles used in the present invention, the coercive force value thereof is usually 0.8 to 159.2 kA/m (10 to 2,000 Oe), preferably 1.6 to 143.2 kA/m (20 to 1,800 Oe); the saturation magnetization value thereof in a magnetic field of 795.8 kA/m (10 kOe) is usually 50 to 150 Am²/kg (50 to 150 emu/g), preferably 60 to 130 Am²/kg (60 to 130 emu/g); and the residual magnetization value thereof in a magnetic field of 795.8 kA/m (10 kOe) is usually 1 to 75 Am²/kg (1 to 75 emu/g), preferably 3 to 65 Am²/kg (3 to 65 emu/g).

In particular, in the case where magnetite particles are used as the magnetic core particles, as to the magnetic properties thereof, the coercive force value thereof is usually 0.8 to 31.8 kA/m (10 to 400 Oe), preferably 1.6 to 30.2 kA/m (20 to 380 Oe); the saturation magnetization value thereof in a magnetic field of 795.8 kA/m (10 kOe) is usually 50 to 91 Am²/kg (50 to 91 emu/g), preferably 60 to 90 Am²/kg (60 to 90 emu/g); and the residual magnetization value thereof in a magnetic field of 795.8 kA/m (10 kOe) is usually 1 to 35 Am²/kg (1 to 35 emu/g), preferably 3 to 30 Am²/kg (3 to 30 emu/g).

The gluing agent used in the present invention is not particularly restricted as long as the organic pigments can be adhered onto the surface of the magnetic particles through the gluing agent. Examples of the gluing agents may include organosilicon compounds such as alkoxysilanes, fluoroalkylsilanes and polysiloxanes; various coupling agents such as silane-based coupling agents, titanate-based coupling agents, aluminate-based coupling agents and zirconate-based coupling agents; oligomers or polymer compounds; or the like. These gluing agents may be used alone or in the form of a mixture of any two or more thereof. In the consideration of adhesion strength of the organic pigments onto the surface of the magnetic particles through the gluing agent, the preferred gluing agents are the organosilicon compounds such as alkoxysilanes, fluoroalkylsilanes and polysiloxanes, and various coupling agents such as silane-based coupling agents, titanate-based coupling agents, aluminate-based coupling agents and zirconate-based coupling agents; the more preferred gluing agents are the organosilicon compounds such as alkoxysilanes, fluoroalkylsilanes and polysiloxanes; and the still more preferred gluing agents are alkoxysilanes and polysiloxanes.

In the present invention, as the organosilicon compound, there may be used organosilane compounds obtainable from alkoxysilanes, polysiloxanes, modified polysiloxanes, terminal-modified polysiloxanes, fluoroalkylsilanes, or mixtures thereof.

The organosilane compounds can be produced from alkoxysilane compounds represented by the formula (I):

R¹ₐSiX₄₋ₐ (I)

wherein R¹ is C₆H₅—, (CH₃)₂CHCH₂— or n-C_{b}H_{2b+1}— (wherein b is an integer of 1 to 18); X is CH₃O— or C₂H₅O—; and a is an integer of 0 to 3.

Specific examples of the alkoxysilane compounds may include methyltriethoxysilane, dimethyldiethoxysilane, phenyltriethyoxysilane, diphenyldiethoxysilane, dimethyldimethoxysilane, methyltrimethoxysilane, phenyltrimethoxysilane, diphenyldimethoxysilane, isobutyltrimethoxysilane, decyltrimethoxysilane or the like.

Among these alkoxysilane compounds, in view of the adhering effect of the organic pigments to the surface of the magnetic particles, methyltriethoxysilane, methyltrimethoxysilane, dimethyldimethoxysilane, isobutyltrimethoxysilane and phenyltriethyoxysilane are preferred, and methyltriethoxysilane, methyltrimethoxysilane, dimethyldimethoxysilane and phenyltriethyoxysilane are more preferred.

As the polysiloxanes, there may be used those compounds represented by the formula (II):

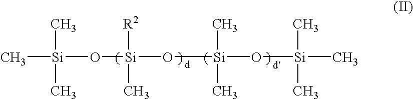

wherein R² is H— or CH₃—, d is an integer of 15 to 370, and d′ is an integer of 15 to 370.

As the modified polysiloxanes, there may be used (a) polysiloxanes modified with polyethers represented by the formula (III):

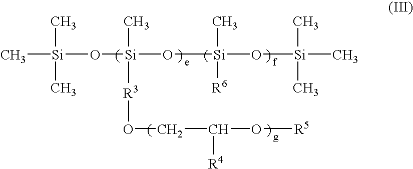

wherein R³ is —(—CH₂—)ₕ—; R⁴ is —(—CH₂—)ᵢ—CH₃; R⁵ is —OH, —COOH, —CH═CH₂, —C(CH₃)═CH₂ or —(—CH₂—)ⱼ—CH₃; R⁶ is —(—CH₂—)ₖ—CH₃; g and h are an integer of 1 to 15; i, j and k are an integer of 0 to 15; e is an integer of 1 to 50; and f is an integer of 1 to 300;

(b) polysiloxanes modified with polyesters represented by the formula (IV):

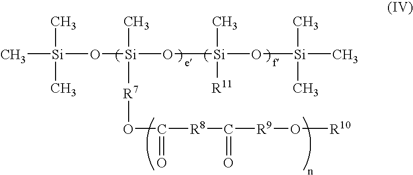

wherein R⁷, R⁸ and R⁹ are —(—CH₂—)_{q}— and may be the same or different; R¹⁰ is —OH, —COOH, —CH═CH₂, —CH(CH₃)═CH₂ or —(—CH₂—)ᵣ—CH₃; R¹¹ is —(—CH₂—)ₛ—CH₃; n and q are an integer of 1 to 15; r and s are an integer of 0 to 15; e′ is an integer of 1 to 50; and f′ is an integer of 1 to 300; and

(c) polysiloxanes modified with epoxy compounds represented by the formula (V):

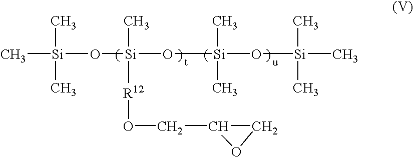

wherein R¹² is —(—CH₂—)ᵥ—; v is an integer of 1 to 15; t is an integer of 1 to 50; and u is an integer of 1 to 300; or a mixture thereof.

As the terminal-modified polysiloxanes, there may be used those represented by the formula (IV):

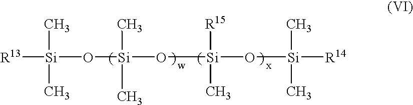

wherein R¹³ and R¹⁴ are —OH, R¹⁶OH or R¹⁷COOH and may be the same or different; R¹⁵ is —CH₃ or —C₆H₅; R¹⁶ and R¹⁷ are —(—CH₂—)_{y}—; y is an integer of 1 to 15; w is an integer of 1 to 200; and x is an integer of 0 to 100.

Among these polysiloxanes, in view of the adhering effect of the organic pigment, polysiloxanes having methyl hydrogen siloxane units, the polysiloxanes modified with the polyethers represented by the formula (III), and the polysiloxanes whose terminals are modified with carboxylic acid groups, are preferred.

The fluoroalkyl organosilane compounds may be produced from fluoroalkylsilane compounds represented by the formula (VII):

CF₃(CF₂)_{z}CH₂CH₂(R¹⁸)ₐ′SiX_{3-a′} (VII)

wherein R¹⁸ is CH₃—, C₂H₅—, CH₃O— or C₂H₅O—; X is CH₃O— or C₂H₅O—; and z is an integer of 0 to 15; and a′ is an integer of 0 to 2.

Specific examples of the fluoroalkylsilane compounds may include trifluoropropyl trimethoxysilane, tridecafluorooctyl trimethoxysilane, heptadecafluorodecyl trimethoxysilane, heptadecafluorodecylmethyl dimethoxysilane, trifluoropropyl triethoxysilane, tridecafluorooctyl triethoxysilane, heptadecafluorodecyl triethoxysilane, or the like.

Among these fluoroalkylsilane compounds, in view of the adhering effect of the organic pigment, trifluoropropyl trimethoxysilane, tridecafluorooctyl trimethoxysilane and heptadecafluorodecyl trimethoxysilane are preferred, and trifluoropropyl trimethoxysilane and tridecafluorooctyl trimethoxysilane are more preferred.

As the silane-based coupling agents, there may be exemplified vinyltrimethoxysilane, vinyltriethoxysilane, γ-aminopropyltriethoxysilane, γ-glycidoxypropyltrimethoxysilane, γ-mercaptopropyltrimethoxysilane, γ-methacryloxypropyltrimethoxysilane, N-β(aminoethyl)-γ-aminopropyltrimethoxysilane, γ-glycidoxypropylmethyldimethoxysilane, γ-chloropropyltrimethoxysilane or the like.

As the titanate-based coupling agents, there may be exemplified isopropyltristearoyl titanate, isopropyltris(dioctylpyrophosphate)titanate, isopropyltri(N-aminoethyl-aminoethyl)titanate, tetraoctylbis(ditridecylphosphate)titanate, tetra(2,2-diaryloxymethyl-1-butyl)bis(ditridecyl)phosphate titanate, bis(dioctylpyrophosphate)oxyacetate titanate, bis(dioctylpyrophosphate)ethylene titanate or the like.

As the aluminate-based coupling agents, there may be exemplified acetoalkoxyaluminum diisopropilate, aluminumdiisopropoxymonoethylacetoacetate, aluminumtrisethylacetoacetate, aluminumtrisacetylacetonate or the like.

As the zirconate-based coupling agents, there may be exemplified zirconiumtetrakisacetylacetonate, zirconiumdibutoxybisacetylacetonate, zirconiumtetrakisethylacetoacetate, zirconiumtributoxymonoethylacetoacetate, zirconiumtributoxyacetylacetonate or the like.

It is preferred to use oligomer compounds having a molecular weight of from 300 to less than 10,000. It is more preferred to use polymer compounds having a molecular weight of 10,000 to about 100,000. In the consideration of forming a uniform coating layer on the magnetic particles, the oligomers or polymer compounds are preferably in a liquid state, or soluble in water or various solvents.

The amount of the gluing agent coating layer is preferably 0.01 to 15.0% by weight, more preferably 0.02 to 12.5% by weight, still more preferably 0.03 to 10.0% by weight (calculated as C) based on the total weight of the gluing agent and the magnetic particles as core particles.

When the amount of the gluing agent coating layer is less then 0.01% by weight, it may be difficult to adhere onto the gluing agent coating layer, the organic pigments in an amount of not less than 1 part by weight based on 100 parts by weight of the magnetic particles. The amount of the gluing agent coating layer of up to 15.0% by weight is sufficient to adhere the organic pigments in an amount of 1 to 200 parts by weight as aimed by the present invention. Therefore, the amount of the gluing agent coating layer of more than 15.0% by weight is unnecessary.

As the organic pigments used in the present invention, there may be used various organic pigments showing yellow, magenta and cyan colors required for color toners, such as organic yellow-based pigments (Yellow), organic red-based pigments (Magenta) and organic blue-based pigments (Cyan). Also, the respective organic pigments may be used in combination with other organic pigments having different hues, for example, organic pigments which are concerned with a complementary color to each of the organic yellow-based pigments, the organic red-based pigments and the organic blue-based pigments, in order to improve spectral characteristics of the obtained magnetic composite particles.

Examples of the organic yellow-based pigments may include monoazo-based pigments such as Hanza yellow, disazo-based pigments such as benzidine yellow and permanent yellow, condensed azo pigments such as condensed azo yellow, isoindoline-based pigments such as isoindoline yellow, isoindolinone-based pigments such as isoindolinone yellow, or the like.

Examples of the organic red-based pigments may include quinacridone pigments such as quinacridone red, azo-based pigments such as permanent red, condensed azo pigments such as condensed azo red, vat dye-based pigments such as dianthraquinonyl red, perylene-based pigments such as perylene red, diketopyrrolopyrrole-based pigments such as diketopyrrolopyrrole red, or the like. Examples of the organic blue-based pigments may include phthalocyanine-based pigments such as metal-free phthalocyanine blue, phthalocyanine blue (copper phthalocyanine) and fast sky blue (sulfonated copper phthalocyanine), alkali blue, or the like.

The amount of the organic pigments adhered is usually 1 to 200 parts by weight, preferably 3 to 150 parts by weight, more preferably 5 to 100 parts by weight based on 100 parts by weight of the magnetic particles. In particular, when the organic blue-based pigments are used, the amount of the organic blue-based pigments adhered is preferably from more than 50 parts by weight to 200 parts by weight, more preferably 55 to 150 parts by weight, still more preferably 60 to 100 parts by weight based on 100 parts by weight of the magnetic particles.

When the amount of the organic pigments adhered is less than 1 part by weight, the amount of the organic pigments adhered becomes insufficient, so that the magnetic color toner obtained using such a small amount of the organic pigments may fail to exhibit a clear hue. When the amount of the organic pigments adhered is more than 200 part by weight, the amount of the organic pigments adhered becomes too large, resulting in deteriorated magnetic properties of the obtained particles.

The particle shape and particle size of the magnetic composite particles for magnetic color toner according to the present invention largely depend upon those of the magnetic particles as core particles, and has a similar particle configuration to that of the core particles.

More specifically, the magnetic composite particles have an average particle diameter (average major axis diameter in the case of anisotropic particles) of usually 0.06 to 10.0 μm. When the average particle diameter of the magnetic composite particles is less than 0.06 μm, the tinting strength of the obtained particles may become too high due to fine particles, so that the magnetic color toner obtained by using such particles may fail to exhibit a clear hue. When the average particle diameter of the magnetic composite particles is more than 10.0 μm, the particles have a too large particle size which is the substantially same as that of the magnetic color toner.

Also, the magnetic composite particles of the present invention preferably have a hiding power as low as possible. Therefore, the average particle diameter of the magnetic composite particles is preferably out of the range near 0.3 μm at which the light scattering coefficient is highest and, therefore, the hiding power shows a maximum value. More specifically, the average particle diameter of the magnetic composite particles is preferably from 0.06 to 0.25 μm or from 0.35 to 7.5 μm, more preferably from 0.06 to 0.2 μm or from 0.4 to 5.0 m.

The magnetic composite particles of the present invention have a geometrical standard deviation of particle diameter (major axis diameter in the case of anisotropic particles) of usually 1.01 to 2.5, preferably 1.01 to 2.4, more preferably 1.01 to 2.3. When the geometrical standard deviation of the magnetic composite particles is more than 2.5, coarse particles may be present in the obtained magnetic composite particles, resulting in deteriorated dispersibility in binder resin upon production of the magnetic color toner.

The magnetic composite particles of the present invention have a BET specific surface area value of usually 1.0 to 100 m²/g, preferably 1.5 to 95 m²/g, more preferably 2.0 to 90 m²/g. When the BET specific surface area value is more than 100 m²/g, the tinting strength of the obtained particles may become too high due to fine particles, so that the magnetic color toner obtained from such magnetic composite particles may fail to exhibit a clear hue.

As to the hue of the magnetic composite particles of the present invention, the lower limit of the L* value thereof is usually 18.0, preferably 19.0, and the upper limit of the L* value thereof is usually about 50.0. When the L* value of the magnetic composite particles is less than 18.0, the particles exhibit a too high blackness, so that the magnetic color toner obtained from such magnetic composite particles may fail to exhibit a clear hue.

When the organic yellow-based pigments are used as the organic pigments to be adhered, the b* value of the obtained magnetic composite particles is usually more than 0.0, preferably not less than 3.0, more preferably not less than 5.0. In the effect of improving the hue of the magnetic color toner, the b* value of the magnetic composite particles is higher by preferably not less than 1.0, more preferably not less than 2.0, still more preferably not less than 3.0, than the b* value of the core particles.

When the organic red-based pigments are used as the organic pigments to be adhered, the a* value of the obtained magnetic composite particles is usually not less than 0.0, preferably not less than 3.0, more preferably not less than 5.0. In the effect of improving the hue of the magnetic color toner, the a* value of the magnetic composite particles is higher by preferably not less than 1.0, more preferably not less than 2.0, still more preferably not less than 3.0, than the a* value of the core particles.

When the organic blue-based pigments are used as the organic pigments to be adhered, the b* value of the obtained magnetic composite particles is usually not more than 0.0, preferably not more than −0.5, more preferably not more than −1.0. In the effect of improving the hue of the magnetic color toner, the b* value of the magnetic composite particles is lower by preferably not less than 0.5, more preferably not less than 1.0, still more preferably not less than 1.5, than the b* value of the core particles.

As to the light resistance of the magnetic composite particles, the ΔE* value thereof is usually not more than 5.0, preferably not more than 4.0 when measured by the below-mentioned method.

The magnetic composite particles of the present invention have a desorption percentage of organic pigments of usually not more than 15%, preferably not more than 12%. When the desorption percentage of organic pigments from the magnetic composite particles is more than 15%, the magnetic composite particles may be inhibited from being uniformly dispersed because of the desorbed organic pigments, and the hue of the magnetic particles as core particles is disadvantageously exposed to the surface portion of the magnetic composite particles where the organic pigments are desorbed. As a result, when such magnetic composite particles are used, it may be difficult to produce a magnetic color toner exhibiting a clear hue.

The magnetic properties of the magnetic composite particles may be controlled by appropriately selecting kind, particle shape, particle size, etc. of magnetic particles as core particles. The magnetic composite particles may usually have the substantially same magnetic properties as those of ordinary magnetic particles used for magnetic color toners. More specifically, the coercive force value of the magnetic composite particles is usually 0.8 to 159.2 kA/m (10 to 2,000 Oe), preferably 1.6 to 143.2 kA/m (20 to 1,800 Oe); the saturation magnetization value thereof in a magnetic field of 795.8 kA/m (10 kOe) is usually 50 to 150 Am²/kg (50 to 150 emu/g), preferably 60 to 130 Am²/kg (60 to 130 emu/g); and the residual magnetization value thereof in a magnetic field of 795.8 kA/m (10 kOe) is usually 1 to 75 Am²/kg (1 to 75 emu/g), preferably 3 to 65 Am²/kg (3 to 65 emu/g).

In particular, when magnetite particle are used as core particles of the magnetic composite particles, the coercive force value of the magnetic composite particles is usually 0.8 to 31.8 kA/m (10 to 400 Oe), preferably 1.6 to 30.2 kA/m (20 to 380 Oe); the saturation magnetization value thereof in a magnetic field of 795.8 kA/m (10 kOe) is usually 50 to 91 Am²/kg (50 to 91 emu/g), preferably 60 to 90 Am²/kg (60 to 90 emu/g); and the residual magnetization value thereof in a magnetic field of 795.8 kA/m (10 kOe) is usually 1 to 35 Am²/kg (1 to 35 emu/g), preferably 3 to 30 Am²/kg (3 to 30 emu/g).

Upon the production of the magnetic composite particles of the present invention, the surface of the magnetic particle as core particle may be previously coated, if required, with at least one undercoating material selected from the group consisting of hydroxides of aluminum, oxides of aluminum, hydroxides of silicon and oxides of silicon. The magnetic composite particles obtained by using the magnetic particles coated with an undercoating material can be more effectively prevented from undergoing desorption of the organic pigments therefrom as compared to the magnetic composite particles obtained by using the magnetic particles coated with no undercoating material.

The amount of the undercoating material coat is preferably 0.01 to 20% by weight (calculated as Al, SiO₂ or a sum of Al and SiO₂) based on the total weight of the magnetic particles coated. When the amount of the undercoating material coat is less than 0.01% by weight, it may be difficult to obtain the improving effect of preventing the organic pigments from being desorbed from the magnetic composite particles. As long as the amount of the undercoating material coat lies within the above-specified range of 0.01 to 20% by weight, the improving effect of preventing the desorption of the organic pigments can be sufficiently exhibited. Therefore, it is unnecessary to form the undercoating material coat in an amount exceeding 20% by weight.

The particle size, geometrical standard deviation, BET specific surface area value, hue (L*, a* and b* values), light resistance (ΔE* value) and magnetic properties of the magnetic composite particles obtained by using as core particles the magnetic particles having the undercoating material coat according to the present invention, are substantially same as those of the magnetic composite particles obtained by using as core particles the magnetic particles having no undercoating material coat according to the present invention. In addition, by forming the undercoating material coat on the magnetic particles as core particles, the desorption percentage of the organic pigments from the obtained magnetic composite particles can be reduced so as to be preferably not more than 12%, more preferably not more than 10%.

Next, the magnetic color toner of the present invention is described.

The magnetic color toner of the present invention comprises the above-described magnetic composite particles, a colorant and a binder resin, and may also contain, if required, a mold release agent, a charge controller and other additives.

The magnetic color toner of the present invention has an average particle diameter of usually 1.0 to 25 μm, preferably 2.0 to 20 μm, more preferably 3.0 to 15 μm.

The amount of the magnetic composite particles blended in the magnetic color toner is usually 1 to 25% by weight, preferably 2 to 20% by weight based on the total weight of the magnetic color toner. When the amount of the magnetic composite particles blended is less than 1% by weight, it may be difficult to impart sufficient magnetic properties to the obtained magnetic color toner. When the amount of the magnetic composite particles blended is more than 25% by weight, it may be difficult to exhibit an inherent hue of the colorant due to adverse influence by the hue of the magnetic particles.

As the binder resin, there may be used polyester-based resins, polystyrene-based resins, acrylic resins, styrene-acrylic acid ester copolymers, epoxy-based resins, polyolefin-based resins, or the like.

As to the hue of the magnetic color toner of the present invention, the C* value thereof is preferably not less than 18.0, more preferably not less than 19.0, most preferably not less than 20.0. In particular, when the organic red-based pigments or the organic yellow-based pigments are used as the organic pigments adhered, the C* value of the obtained magnetic color toner is preferably not less than 40.0, more preferably not less than 41.0, most preferably not less than 42.0. When the C* value of the magnetic color toner is less than 18.0, the magnetic color toner may fail to show a clear hue.

As to the light resistance of the magnetic color toner, the ΔE* value thereof is usually not more than 5.0, preferably not more than 4.0 when measured by the below-mentioned method.

Next, the developing methods of the present invention are described.

The developing methods of the present invention may be conducted by either one-component or two-component developing method as long as a magnetic toner is usable in these methods. In the developing methods of the present invention, the magnetic color toner of the present invention is used as a developer.

More specifically, the one-component developing method is the following method for developing a magnetic latent image. That is, a magnetic latent image is first formed on the surface of an image-retaining member made of a magnetic material. Then, a developer containing a magnetic color toner is supplied onto a non-magnetic sleeve disposed opposite to the surface of the image-retaining member made of a magnetic material and provided inside thereof with a magnetic field-generating element to form a magnetic brush on the non-magnetic sleeve. The magnetic brush thus formed on the non-magnetic sleeve is brought into sliding contact with the surface of the image-retaining member to develop the magnetic latent image.

In the above magnetic latent image developing method, an alternating current bias voltage may be applied between the magnetic color toner and the image-retaining member made of a magnetic material.

Also, the two-component developing method is the following method for developing an electrostatic image. That is, an electrostatic image is first formed on the surface of a photosensitive member or an electrostatic charge-retaining member. Then, a developer in which a magnetic carrier and a magnetic color toner are blended, is supplied onto a non-magnetic sleeve disposed opposite to the surface of the photosensitive member or the electrostatic charge-retaining member made of a magnetic material and provided inside thereof with a magnetic field-generating element to form a magnetic brush on the non-magnetic sleeve. The magnetic brush thus formed on the non-magnetic sleeve is brought into sliding contact with the surface of the photosensitive member or the electrostatic charge-retaining member to develop the electrostatic image.

In the above electrostatic image developing method, an alternating current bias voltage may be applied between the magnetic color toner and the photosensitive member or the electrostatic charge-retaining member.

As the magnetic carrier used in the two-component developing method, there may be used known magnetic carriers. Specific examples of the magnetic carriers may include iron oxide-based carriers composed of magnetite or soft ferrite such as Ni—Zn-based ferrite, Mg—Zn-based ferrite, Cu—Zn-based ferrite and Ba—Ni—Zn-based ferrite, composite carriers containing an iron powder carrier, a resin and magnetic particles, or the like.

The magnetic carrier has an average particle diameter of usually 10 to 200 μm, preferably 20 to 150 μm.

In the case where the magnetic color toner of the present invention is used in the above developing methods, it is possible to not only prevent occurrence of fogging on a background portion, but also obtain images having a high density and an excellent durability.

The image density is preferably not less than 1.10, more preferably not less than 1.20.

As to the image durability, the percentage of change in the image density is preferably not more than 10%, more preferably not more than 8%, still more preferably not more than 6%.

As to the image fogging, the ΔL* value is preferably not more than 4.0, more preferably not more than 3.0 when measured by the below-mentioned method.

Next, the process for producing the magnetic composite particles for magnetic color toner according to the present invention is described.

The magnetic composite particles of the present invention can be produced by mixing magnetic particles with a gluing agent to form a gluing agent coating layer on the surface of the magnetic particles, and then mixing the magnetic particles having the gluing agent coating layer thereon with organic pigments.

The gluing agent coat may be formed on the surface of the magnetic particles by mechanically mixing and stirring the magnetic particles with the gluing agent or a solution of the gluing agent, or by mechanically mixing and stirring the magnetic particles while spraying the gluing agent or a solution of the gluing agent thereonto. Substantially whole amount of the gluing agent added is adhered on the surface of the magnetic particles for forming the gluing agent coat thereon.

Meanwhile, in the case where alkoxysilanes or fluoroalkylsilanes are used as the gluing agent, a part of the alkoxysilanes or fluoroalkylsilanes adhered may be coated in the form of organosilane compounds obtainable from the alkoxysilanes, or fluorine-containing organosilane compounds obtainable from the fluoroalkylsilanes, through the coating step. In any of these cases, subsequent adhesion of the organic pigments on the gluing agent coat is not adversely affected.

In order to uniformly adhere the gluing agent over the surface of the magnetic particles, it is preferred that the agglomerated magnetic particles are previously deaggregated using a pulverizer.

As the apparatuses for mixing and stirring the magnetic particles with the gluing agent, or mixing and stirring the organic pigments with the gluing agent-coated magnetic particles, there may be used those apparatuses capable of applying a shear force to a layer composed of these particles, in particular, such apparatuses capable of effecting shear action, spatula stroking and compression at the same time. Examples of such apparatuses may include wheel-type kneaders, ball-type kneaders, blade-type kneaders, roll-type kneaders or the like. Among these apparatuses, the wheel-type kneaders can be more effectively used in the present invention.

Specific examples of the wheel-type kneaders may include edge runners (similar in meaning to mix muller, Simpson mill and sand mill), multimill, Stotz mill, Wet pan mill, corner mill, ring muller or the like. Among these kneaders, preferred are edge runners, multimill, Stotz mill, Wet pan mill and ring muller, and more preferred are edge runners.

Specific examples of the ball-type kneaders may include vibration mill or the like. Specific examples of the blade-type kneaders may include Henschel mixer, planetary mixer, Nauter mixer or the like. Specific examples of the roll-type kneaders may include extruders or the like.

The conditions of the mixing and stirring treatment may be selected so as to uniformly coat the surface of the magnetic particles with the gluing agent. Specifically, the mixing and stirring conditions may be appropriately controlled such that the linear load is usually 19.6 to 1,960 N/cm (2 to 200 Kg/cm), preferably 98 to 1,470 N/cm (10 to 150 Kg/cm), more preferably 147 to 980 N/cm (15 to 100 Kg/cm); the treating time is usually 5 minutes to 24 hours, preferably 10 minutes to 20 hours; and the stirring speed is usually 2 to 2,000 rpm, preferably 5 to 1,000 rpm, more preferably 10 to 800 rpm.

The mixing and stirring of the magnetic particles with other components is preferably conducted after purging the mixing apparatus with an inert gas such as N₂ in order to prevent the magnetic properties thereof from being deteriorated due to oxidation.

The amount of the gluing agent added is preferably 0.15 to 45 parts by weight based on 100 parts by weight of the magnetic particles. When the gluing agent is added in an amount of 0.15 to 45 parts by weight, it is possible to adhere 1 to 200 parts by weight of the organic pigment based on 100 parts by weight of the magnetic particles.

After the surface of the magnetic particles is coated with the gluing agent, the organic pigment is added, and then mixed and stirred with the coated magnetic particles to adhere the organic pigment onto the gluing agent-coating layer. The obtained particles may be further subjected to drying or heating treatments, if required.

The amount of the organic pigments added is usually 1 to 200 parts by weight, preferably 3 to 150 parts by weight, more preferably 5 to 100 parts by weight based on 100 parts by weight of the magnetic particles. When the amount of the organic pigments added is out of the above-specified range, it may be difficult to obtain the aimed magnetic composite particles.

It is preferred that the organic pigments are gradually added little by little for a period of preferably about 5 minutes to about 24 hours, more preferably about 5 minutes to about 20 hours, or the organic pigments of 5 to 25 parts by weight based on 100 parts by weight of the magnetic particles are intermittently added until reaching the desired total amount thereof.

The mixing and stirring conditions may be appropriately selected so as to form a uniform organic pigment coat on the gluing agent-coating layer, and may be controlled such that the linear load is usually 19.6 to 1,960 N/cm (2 to 200 Kg/cm), preferably 98 to 1,470 N/cm (10 to 150 Kg/cm), more preferably 147 to 980 N/cm (15 to 100 Kg/cm); the treating time is usually 5 minutes to 24 hours, preferably 10 minutes to 20 hours; and the stirring speed is usually 2 to 2,000 rpm, preferably 5 to 1,000 rpm, more preferably 10 to 800 rpm.

The heating temperature used upon the drying and heating treatments is usually 40 to 150° C., preferably 60 to 120° C. The heating time is usually from 10 minutes to 12 hours, preferably from 30 minutes to 3 hours.

Meanwhile, when alkoxysilanes or fluoroalkylsilanes are used as the gluing agent, a coating layer comprising organosilane compounds obtainable from the alkoxysilanes or fluorine-containing organosilane compounds obtainable from the fluoroalkylsilanes, is finally formed on the respective magnetic particles via these treatment steps.

If required, prior to mixing and stirring with the gluing agents, the magnetic particle may be preliminarily coated with at least one undercoating material selected from the group consisting of hydroxides of aluminum, oxides of aluminum, hydroxides of silicon and oxides of silicon to form an undercoating layer thereon.

The coating of the undercoating material may be conducted by adding an aluminum compound, a silicon compound or both the compounds to a water suspension in which the magnetic particle are dispersed, followed by mixing and stirring, and further adjusting the pH value of the suspension, if required, thereby coating the surfaces of the magnetic particle with the undercoating material. The thus obtained magnetic particle coated with the undercoating material are then filtered out, washed with water, dried and pulverized. Further, the magnetic particle coated with the undercoating material may be subjected to post-treatments such as deaeration treatment and compaction treatment, if required.

As the aluminum compounds, there may be exemplified aluminum salts such as aluminum acetate, aluminum sulfate, aluminum chloride or aluminum nitrate, alkali aluminates such as sodium aluminate or the like.

The amount of the aluminum compound added is 0.01 to 20% by weight (calculated as Al) based on the weight of the magnetic particle. When the amount of the aluminum compound added is less than 0.01% by weight, it may be difficult to sufficiently coat the surfaces of the magnetic particle with hydroxides and/or oxides of aluminum, thereby failing to improve the effective reduction of the organic pigment desorption percentage. On the other hand, when the amount of the aluminum compound added is more than 20% by weight, the coating effect is saturated and, therefore, it is meaningless to add such an excess amount of the aluminum compound.

As the silicon compounds, there may be exemplified #3 water glass, sodium orthosilicate, sodium metasilicate or the like.

The amount of the silicon compound added is 0.01 to 20% by weight (calculated as SiO₂) based on the weight of the magnetic particle. When the amount of the silicon compound added is less than 0.01% by weight, it may be difficult to sufficiently coat the surfaces of the magnetic particle with hydroxides and/or oxides of silicon, thereby failing to improve the effective reduction of the organic pigment desorption percentage. On the other hand, when the amount of the silicon compound added is more than 20% by weight, the coating effect is saturated and, therefore, it is meaningless to add such an excess amount of the silicon compound.

In the case where both the aluminum and silicon compounds are used in combination for the coating, the total amount of the aluminum and silicon compounds added is preferably 0.01 to 20% by weight (calculated as a sum of Al and SiO₂) based on the weight of the magnetic particle.

Next, the process for producing the magnetic color toner according to the present invention is described.

The magnetic color toner of the present invention can be produced by a known method, i.e., by blending a predetermined amount of the binder resin, a predetermined amount of magnetic composite particles and a predetermined amount of a colorant with each other, and then subjecting the resultant mixture to kneading and pulverization. More specifically, the magnetic composite particles, the binder resin and the colorant are charged, if required, together with a mold release agent, a charge controller and other additives, into a mixing apparatus, and intimately mixed together therein. The resultant mixture is kneaded by a heating kneader to disperse the magnetic composite particles, etc. in the binder resin, and then cooled and solidified, thereby obtaining a kneaded resin material. Successively, the kneaded resin material is pulverized and classified to obtain particles having the aimed particle size.

As the mixing apparatus, there may be used a Henschel mixer, a ball mill or the like. As the heating kneader, there may be used a roll mill, a kneader, a twin-screw extruder or the like. Also, the pulverization may be conducted using any suitable pulverizer such as a cutter mill and a jet mill. The classification may be conducted by a known method such as air classification as described in Japanese Patent No. 2683142, etc.

The magnetic color toner may also be produced by an alternative method such as a suspension polymerization method and an emulsion polymerization method. In the suspension polymerization method, the polymerizable monomer, the magnetic composite particles and the colorant are mixed, if required, together with a polymerization initiator, a cross-linking agent, a charge controller and other additives, and the resultant mixture is dissolved or dispersed to obtain a monomer composition. The thus obtained monomer composition is then added to a water phase containing a suspension stabilizer while stirring, granulated and then polymerized, thereby obtaining a magnetic color toner having the aimed particle size.

Also, in the emulsion polymerization method, the monomer, the magnetic composite particles and the colorant are dispersed in water, if required, together with a polymerization initiator or the like, and then polymerized by adding an emulsifier thereto, thereby obtaining a magnetic color toner having the aimed particle size.

The point of the present invention is that when the magnetic composite particles obtained by forming a gluing agent coating layer on the surface of magnetic particles and adhering organic pigments on the gluing agent coating layer are used as magnetic particles for magnetic color toner, it is possible to obtain a magnetic color toner exhibiting not only a clear hue but also an excellent light resistance.

The reason why the magnetic composite particles of the present invention can exhibit a clear hue when used as magnetic particles for magnetic color toner, is considered by the present inventors as follows. That is, since the particle size of the magnetic composite particles is nearly the same as that of the magnetic particles as core particles, the organic pigments are adhered in the form of fine particles onto the surface of the magnetic particles. As a result, it is considered that the fine organic pigments adhered not only can reduce the blackness of the magnetic particles as core particles, but also can enhance a chroma of the obtained magnetic composite particles.

Also, it is considered that since the magnetic particles as core particles are selected from those having a hiding power as low as possible, the obtained magnetic composite particles can allow the organic pigments adhered thereonto to more clearly exhibit the inherent hue thereof, as compared to the conventional magnetic particles used as a black colorant for magnetic toners.

For this reason, it is considered that the magnetic color toner obtained by using such magnetic composite particles can be more effectively prevented from undergoing adverse influence on hue of the colorant by the magnetic particles while maintaining good magnetic properties required for magnetic toners. As a result, it is considered that the obtained magnetic color toner can exhibit a clear hue.

In addition, the reason why not only a less image fogging but also high image density and excellent image durability can be attained by the developing processes of the present invention, is considered to be that the magnetic color toner in which the magnetic composite particles and the organic pigments as a colorant are uniformly dispersed, is used therein.

Namely, since the organic pigments are firmly bonded onto the surface of the gluing agent coating layer, the amount of the organic pigments desorbed from the surface of the magnetic composite particles is considerably reduced. As a result, the magnetic composite particles can be well dispersed in the binder resin without disturbance by the desorbed organic pigments. Further, since the compatibility between the magnetic composite particles and the binder resin is enhanced by forming a gluing agent coating layer on the surface of the magnetic particles and adhering the organic pigments onto the gluing agent coating layer, the dispersibility of the magnetic composite particles in the binder resin can be improved. As a result, it is considered that it becomes possible to obtain a magnetic color toner in which the magnetic composite particles and the organic pigments as a colorant are uniformly dispersed.

Thus, the magnetic composite particles of the present invention can be suitably used as magnetic particles for magnetic color toner which are capable of producing a magnetic color toner exhibiting not only a clear hue but also an excellent light resistance.

Also, the magnetic color toner of the present invention can exhibit a clear hue and an excellent light resistance and, therefore, can be suitably used as a magnetic color toner.

In addition, the developing methods of the present invention can ensure not only a less image fogging, but also a high image density and an excellent image durability and, therefore, can be suitably applied to developing methods using a magnetic color toner.

### EXAMPLES

The present invention is described in more detail by Examples and Comparative Examples, but the Examples are only illustrative and, therefore, not intended to limit the scope of the present invention thereto.

Various properties were measured by the following methods.

(1) The average particle diameter, average major axis diameter and average minor axis diameter of the particles were respectively expressed by average values of measured particle diameters, major axis diameters and minor axis diameters of 350 particles which were sampled from a micrograph obtained by magnifying an original electron micrograph (×20,000) by four times in each of the longitudinal and transverse directions.

(2) The geometrical standard deviation of particle sizes was expressed by values obtained by the following method. That is, the particle sizes (major axis diameters) were measured from the above magnified electron micrograph. The actual particle sizes (major axis diameters) and the number of the particles were obtained from the calculation on the basis of the measured values. On a logarithmic normal probability paper, the particle sizes (major axis diameters) were plotted at regular intervals on the abscissa-axis and the accumulative number (under integration sieve) of particles belonging to each interval of the particle sizes (major axis diameters) were plotted by percentage on the ordinate-axis by a statistical technique.

The particle sizes (major axis diameters) corresponding to the number of particles of 50% and 84.13%, respectively, were read from the graph, and the geometrical standard deviation (under integration sieve) was measured from the following formula:

$$Geometrical standard deviation = \{ particle sizes ( major axis diameters ) corresponding to 84.13 \% under integration sieve \} / \{ particle sizes ( major axis diameters ) ( geometrical average diameter ) corresponding to 50 \% under integration sieve \}$$

The closer to 1 the geometrical standard deviation value, the more excellent the particle size distribution of the particle sizes (major axis diameters).

(3) The specific surface area was expressed by values measured by a BET method.

(4) The amounts of Al and Si which were present within magnetic particles or on the surfaces thereof were measured by a fluorescent X-ray spectroscopy device “3063 M-type” (manufactured by RIGAKU DENKI KOGYO CO., LTD.) according to JIS K0119 “General rule of fluorescent X-ray analysis”.

(5) The amounts of the gluing agent-coating layer formed on the surface of the magnetic particles, and the organic pigment coat formed on the gluing agent-coating layer were respectively determined by measuring the carbon contents using “Horiba Metal, Carbon and Sulfur Analyzer EMIA-2200 Model” (manufactured by HORIBA SEISAKUSHO CO., LTD.).

(6) The hue of each of the magnetic particles, magnetic composite particles, organic pigment and magnetic color toner, were measured by the following method.

That is, 0.5 g of each sample and 1.5 ml of castor oil were intimately kneaded together by a Hoover's muller to form a paste. 4.5 g of clear lacquer was added to the obtained paste and was intimately kneaded to form a paint. The obtained paint was applied on a cast-coated paper by using a 150 μm (6-mil) applicator to produce a coating film piece (having a film thickness of about 30 μm). The thus obtained coating film piece was measured by a multi-spectro-colour-meter “MSC-IS-2D” (manufactured by SUGA TESTING MACHINES MANUFACTURING CO., LTD.) according to JIS Z 8729, to determine L*, a* and b* values thereof, respectively. Meanwhile, the C* value representing chroma is calculated according to the following formula:

C*=((a*)²+(b*)²)^{1/2}

(7) The hiding power of the magnetic particles and the magnetic composite particles was expressed by the value measured using a primary color enamel prepared by the below-mentioned method, according to JIS K 5101 8.2 “criptometer method”.

Preparation of Primary Color Enamel:

10 g of the sample particles, 16 g of an amino alkyd resin and 6 g of a thinner were blended together. The resultant mixture was added together with 90 g of 3 mmφ glass beads into a 140-ml glass bottle, and then mixed and dispersed for 45 minutes by a paint shaker. The obtained mixture was mixed with 50 g of an amino alkyd resin, and further dispersed for 5 minutes by a paint shaker, thereby obtaining an primary color enamel.

(8) The light resistances of the organic pigments, magnetic composite particles and magnetic color toner were measured by the following method.

Ten grams of sample particles, 16 g of an aminoalkyd resin and 6 g of a thinner were charged together with 90 g of 3 mmφ glass beads into a 140-ml glass bottle, and then mixed and dispersed for 45 minutes by a paint shaker. The resultant mixture was mixed with additional 50 g of the aminoalkyd resin, and further dispersed for 5 minutes by a paint shaker, thereby obtaining a coating composition. The thus obtained coating composition was applied onto a cold-rolled steel plate (0.8 mm×70 mm×150 mm; JIS G-3141) and dried to form a coating film having a thickness of 150 μm. One half of the thus prepared test specimen was covered with a metal foil, and an ultraviolet light was continuously irradiated over the test specimen at an intensity of 100 mW/cm² for 6 hours using “EYE SUPER UV TESTER SUV-W13” (manufactured by Iwasaki Denki Co., Ltd.). Then, the hues (L*, a* and b* values) of the metal foil-covered non-irradiated portion and the UV-irradiated portion of the test specimen were respectively measured. The ΔE* value was calculated from differences between the measured hue values of the metal foil-covered non-irradiated portion and the UV-irradiated portion according to the following formula:

ΔE*=[(ΔL*)²+(Δa*)²+(Δb*)²]^{1/2}

wherein ΔL* represents the difference between L* values of the non-irradiated and UV-irradiated portions; Δa* represents the difference between a* values of the non-irradiated and UV-irradiated portions; and Δb* represents the difference between b* values of the non-irradiated and UV-irradiated portions.

(9) The desorption percentage of the organic pigments desorbed from the magnetic composite particles, is expressed by the value measured by the following method. The closer to 0% the desorption percentage of the organic pigments, the less the amount of the organic pigments desorbed from the surface of the magnetic composite particles.

Three grams of the magnetic composite particles and 40 ml of ethanol were placed in a 50-ml precipitation tube, and subjected to ultrasonic dispersion for 20 minutes. The obtained dispersion was allowed to stand for 120 minutes, thereby separating the dispersion into the magnetic composite particles and the organic pigments desorbed therefrom due to the difference in precipitating speed therebetween. Subsequently, the magnetic composite particles were mixed again with 40 ml of ethanol, and subjected to ultrasonic dispersion for 20 minutes. The obtained dispersion was allowed to stand for 120 minutes, thereby separating the dispersion into the magnetic composite particles and the organic pigments. The thus separated magnetic composite particles were dried at 80° C. for one hour to measure the amount of the organic pigments desorbed therefrom. The desorption percentage (%) of the organic pigments is calculated according to the following formula:

Desorption percentage (%) of organic pigments={(Wab-Web)/Wab}×100

wherein Wab represents an amount of the organic pigments adhered onto the magnetic composite particles; and Web represents an amount of the organic pigments adhered onto the magnetic composite particles after desorption test.

(10) The dispersibility in a binder resin of the magnetic composite particles was evaluated by counting the number of undispersed agglomerated particles on a micrograph (×200 times) obtained by photographing a sectional area of the obtained black magnetic color toner particle using an optical microscope (BH-2, manufactured by Olympus Kogaku Kogyo Co., Ltd.), and classifying the results into the following five ranks. The 5th rank represents the most excellent dispersing condition.

Rank 1: not less than 50 undispersed agglomerated particles per 0.25 mm² were recognized;

Rank 2: 10 to 49 undispersed agglomerated particles per 0.25 mm² were recognized;

Rank 3: 5 to 9 undispersed agglomerated particles per 0.25 mm² were recognized;

Rank 4: 1 to 4 undispersed agglomerated particles per 0.25 mm² were recognized;

Rank 5: No undispersed agglomerated particles were recognized.

(11) The average particle size of the black magnetic toner was measured by a laser diffraction-type particle size distribution-measuring apparatus (Model HELOSLA/KA, manufactured by Sympatec Corp.).

(12) The magnetic properties of the magnetic particles, the magnetic composite particles and magnetic color toner were measured using a vibration sample magnetometer “VSM-3S-15” (manufactured by Toei Kogyo Co., Ltd.) by applying an external magnetic field of 795.8 kA/m (10 kOe) thereto. Whereas, the magnetic properties of the magnetic color toner were measured by applying external magnetic fields of 79.58 kA/m (1 kOe) and 795.8 kA/m (10 kOe) thereto.

(13) The image density was expressed by the average value of five image densities measured at five points of the image printed out on a CLC paper of A4 size (80 g/m²; produced by Canon Co., Ltd.) using a Macbeth reflection densitometer (produced by Macbeth Co., Ltd.).

(14) The image durability was expressed by the value obtained by measuring image densities at five points of the image printed out on a CLC paper of A4 size (80 g/m²; produced by Canon Co., Ltd.) as the 5,000th printout by using a Macbeth reflection densitometer (produced by Macbeth Co., Ltd.), calculating the average value of the five image densities, and inserting the thus calculated average value into the following formula:

Image Durability (%)={(Ca−Ce)/Ca}×100

wherein Ca represents an average value of initial image densities; and Ce represents the average value of image densities obtained at the 5,000th printout.

(15) The image fogging was determined as follows. That is, after repeatedly printing out the image on 5,000 CLC papers of A4 size (80 g/m²; produced by Canon Co., Ltd.), the whiteness L* value of the white image formed on the 5,000th paper by using the respective magnetic color toners, was measured by a multi-spectro-colour-meter “MSC-IS-2D” (manufactured by SUGA SHIKENKI CO., LTD.), thereby determining the fogging on the paper. In the measurement, an amberlite filter, a blue filter and a green filter were used for magnetic color toners containing organic blue-based pigments, organic yellow-based pigments and organic red-based pigments, respectively. The image fogging was expressed by the ΔL* value obtained by subtracting the whiteness (L* value) of a non-image-forming portion of the 5,000th printout from the whiteness (L* value) of the paper before printing. The smaller the ΔL* value, the less the image fogging.

### Example 1

### Production of Magnetic Composite Particles: Magnetic Composite Particles A

20 kg of spherical magnetite particles (average particle diameter: 0.13 μm; geometrical standard deviation value: 1.46; BET specific surface area value: 12.2 m²/g; hiding power: 2,200 cm²/g; L* value: 22.34; a* value: 1.72; b* value: 1.74; coercive force value: 8.0 kA/m (100 Oe); saturation magnetization value in a magnetic field of 795.8 kA/m (10 kOe): 82.8 AM2/kg (82.8 emu/g)) were deagglomerated in 150 liters of pure water using a stirrer, and further passed through a “TK pipeline homomixer” (tradename, manufactured by Tokushu Kika Kogyo Co., Ltd.) three times, thereby obtaining a slurry containing the spherical magnetite particles.

Successively, the obtained slurry containing the spherical magnetite particles was passed through a transverse-type sand grinder “MIGHTY MILL MHG-1.5L” (manufactured by Inoue Seisakusho Co., Ltd.) five times at an axis-rotating speed of 2,000 rpm, thereby obtaining a slurry in which the spherical magnetite particles were dispersed.

The particles in the obtained dispersed slurry which remained on a sieve of 325 meshes (mesh size: 44 μm) was 0%. The slurry was filtered out and washed with water, thereby obtaining a filter cake containing the spherical magnetite particles. After the obtained filter cake containing the spherical magnetite particles was dried at 120° C., 11.0 kg of the dried particles were then charged into an edge runner “MPUV-2 Model” (tradename, manufactured by Matsumoto Chuzo Tekkosho Co., ltd.), and mixed and stirred at 294 N/cm (30 Kg/cm) for 30 minutes while blowing thereinto nitrogen at a rate of 2 liters/min, thereby lightly deagglomerating the particles.

110 g of methyl triethoxysilane (tradename “TSL8123”, produced by GE TOSHIBA SILICONE CO., LTD.) was mixed and diluted with 200 ml of ethanol to obtain a methyl triethoxysilane solution. The methyl triethoxysilane solution was added to the deagglomerated spherical magnetite particles under the operation of the edge runner. The spherical magnetite particles were continuously mixed and stirred at a linear load of 588 N/cm (60 Kg/cm) and a stirring speed of 22 rpm for 30 minutes to form a coating layer composed of methyl triethoxysilane on the surface of the spherical magnetite particles.

Next, 3.3 kg of organic pigments A (kind: Pigment Blue (phthalocyanine-based pigments); particle shape: granular shape; average major axis diameter: 0.06 μm; BET specific surface area value: 71.6 m²/g; L* value: 17.70; a* value: 9.72; b* value: −23.4; light resistance (ΔE* value): 10.84), were added to the above mixture for 30 minutes while operating the edge runner. Further, the obtained mixture was mixed and stirred at a linear load of 588 N/cm (60 Kg/cm) and a stirring speed of 22 rpm for 30 minutes to adhere the organic pigments A on the methyl triethoxysilane coating layer, thereby obtaining composite particles. The obtained composite particles were heat-treated at 80° C. for 60 minutes by using a dryer, thereby obtaining magnetic composite particles A.

The obtained magnetic composite particles A had a average particle diameter of 0.13 μm, a geometrical standard deviation value of 1.46, a BET specific surface area value of 18.6 m²/g, a hiding power of 1,910 cm²/g, an L* value of 23.05, an a* value of −0.15, a b* value of −1.18, a light resistance (ΔE* value) of 2.62, and a desorption percentage of organic pigments of 8.4%. As to the magnetic properties of the magnetic composite particles A, the coercive force thereof was 8.0 kA/m (101 Oe), and the saturation magnetization value thereof in a magnetic field of 795.8 kA/m (10 kOe) was 63.3 Am²/kg (63.3 emu/g). The amount of the coating layer composed of organosilane compounds produced from methyl triethoxysilane was 0.07% by weight (calculated as C), and the amount of the organic pigments A adhered was 15.4% by weight (calculated as C; corresponding to 30.0 parts by weight based on 100 parts by weight of the spherical magnetite particles).

As a result of the observation of electron micrograph, almost no organic pigments A liberated were recognized, so that it was confirmed that a substantially whole amount of the organic pigments A added were adhered onto the coating layer composed of organosilane compounds obtained from methyl triethoxysilane.

### Example 2

### Production of Magnetic Composite Particles: Magnetic Composite Particles B

3.3 kg of organic pigments B (kind: Pigment Red (azo-based pigments); particle shape: granular shape; average major axis diameter: 0.55 μm; BET specific surface area value: 18.6 m²/g; L* value: 39.31; a* value: 49.18; b* value: 19.77; light resistance (ΔE* value): 18.60) were added to 11.0 kg of the spherical magnetite particles coated with methyl triethoxysilane, which were produced by the same method as defined in Example 1, for 30 minutes while operating an edge runner. Further, the obtained mixture was mixed and stirred at a linear load of 588 N/cm (60 Kg/cm) and a stirring speed of 22 rpm for 30 minutes to adhere the organic pigments B on the methyl triethoxysilane coating layer, thereby obtaining composite particles. The obtained composite particles were heat-treated at 80° C. for 60 minutes by using a dryer, thereby obtaining magnetic composite particles B.

The obtained magnetic composite particles B had an average particle diameter of 0.13 μm, a geometrical standard deviation value of 1.46, a BET specific surface area value of 18.6 m²/g, a hiding power of 1,900 cm²/g, an L* value of 25.33, an a* value of 7.16, a b* value of 4.82, a light resistance (ΔE* value) of 3.55, and a desorption percentage of organic pigments of 8.7%. As to the magnetic properties of the magnetic composite particles B, the coercive force thereof was 7.7 kA/m (97 Oe), and the saturation magnetization value thereof in a magnetic field of 795.8 kA/m (10 kOe) was 62.6 Am²/kg (62.6 emu/g). The amount of the coating layer composed of organosilane compounds produced from methyl triethoxysilane was 0.07% by weight (calculated as C), and the amount of the organic pigments B adhered was 13.25% by weight (calculated as C; corresponding to 30.0 parts by weight based on 100 parts by weight of the spherical magnetite particles).

As a result of the observation of electron micrograph, almost no organic pigments B liberated were recognized, so that it was confirmed that a substantially whole amount of the organic pigments B added were adhered onto the coating layer composed of organosilane compounds obtained from methyl triethoxysilane.

### Example 3

### Production of Magnetic Composite Particles: Magnetic Composite Particles C

3.3 kg of organic pigments C (kind: Pigment Yellow (azo-based pigments); particle shape: granular shape; average major axis diameter: 0.73 μm; BET specific surface area value: 10.5 m²/g; L* value: 66.80; a* value: 0.78; b* value: 70.92; light resistance (ΔE* value): 17.33) were added to 11.0 kg of the spherical magnetite particles coated with methyl triethoxysilane, which were produced by the same method as defined in Example 1, for 30 minutes while operating an edge runner. Further, the obtained mixture was mixed and stirred at a linear load of 588 N/cm (60 Kg/cm) and a stirring speed of 22 rpm for 30 minutes to adhere the organic pigments C on the methyl triethoxysilane coating layer, thereby obtaining composite particles. The obtained composite particles were heat-treated at 80° C. for 60 minutes by using a dryer, thereby obtaining magnetic composite particles C.

The obtained magnetic composite particles C had an average particle diameter of 0.13 μm, a geometrical standard deviation value of 1.46, a BET specific surface area value of 20.0 m²/g, a hiding power of 1,820 cm²/g, an L* value of 25.94, an a* value of 0.48, a b* value of 9.32, a light resistance (ΔE* value) of 3.62, and a desorption percentage of organic pigments of 8.8%. As to the magnetic properties of the magnetic composite particles C, the coercive force thereof was 8.1 kA/m (102 Oe), and the saturation magnetization value thereof in a magnetic field of 795.8 kA/m (10 kOe) was 63.4 Am²/kg (63.4 emu/g). The amount of the coating layer composed of organosilane compounds produced from methyl triethoxysilane was 0.07% by weight (calculated as C), and the amount of the organic pigments C adhered was 12.16% by weight (calculated as C; corresponding to 30.0 parts by weight based on 100 parts by weight of the spherical magnetite particles).

As a result of the observation of electron micrograph, almost no organic pigments C liberated were recognized, so that it was confirmed that a substantially whole amount of the organic pigments C added were adhered onto the coating layer composed of organosilane compounds obtained from methyl triethoxysilane.

### Example 4

### Production of Magnetic Color Toner: Magnetic Color Toner A

The magnetic composite particles A obtained in Example 1, the organic pigments A, a polyester resin, a polypropylene wax and a charge controller were charged at the following mixing ratio into a Henschel mixer, and mixed and stirred at a vessel temperature of 60° C. for 15 minutes. The obtained mixed particles were melt-kneaded in a continuous-type twin-screw kneader at 140° C. The obtained kneaded material was cooled in air, coarsely pulverized, finely pulverized and then classified, thereby obtaining a magnetic color toner A.

Composition of mixed particles:

| | | |
|---|---|---|
| Magnetic composite particles A | 10.0 | parts by weight |
| Organic pigments A | 10.0 | parts by weight |
| Polyester resin | 85.0 | parts by weight |
| Polypropylene wax | 10.0 | parts by weight |
| Charge controller | 1.0 | part by weight |

The thus obtained magnetic color toner A had an average particle diameter of 10.0 μm; a dispersibility of the rank 5; an L* value of 21.05; an a* value of 8.41; a b* value of −18.59; a C* value of 20.40; a light resistance (ΔE* value) of 2.45; a coercive force value of 8.0 kA/m (100 Oe); a saturation magnetization value in a magnetic field of 795.8 kA/m (10 kOe) of 6.4 Am²/kg (6.4 emu/g); and a saturation magnetization value in a magnetic field of 79.6 kA/m (1 kOe) of 3.9 Am²/kg (3.9 emu/g).

### Example 5

### Production of Magnetic Color Toner: Magnetic Color Toner B

The same procedure as defined in Example 4 was conducted except that the magnetic composite particles A and the organic pigments A were changed to the magnetic composite particles B obtained in Example 2 and the organic pigments B, respectively, thereby obtaining a magnetic color toner B.

The thus obtained magnetic color toner B had an average particle diameter of 10.2 μm; a dispersibility of the rank 5; an L* value of 34.51; an a* value of 40.12; a b* value of 15.86; a C* value of 43.14; a light resistance (ΔE* value) of 3.39; a coercive force value of 7.6 kA/m (96 Oe); a saturation magnetization value in a magnetic field of 795.8 kA/m (10 kOe) of 6.3 Am²/kg (6.3 emu/g); and a saturation magnetization value in a magnetic field of 79.6 kA/m (1 kOe) of 3.7 Am²/kg (3.7 emu/g).

### Example 6

### Production of Magnetic Color Toner: Magnetic Color Toner C

The same procedure as defined in Example 4 was conducted except that the magnetic composite particles A and the organic pigments A were changed to the magnetic composite particles C obtained in Example 3 and the organic pigments C, respectively, thereby obtaining a magnetic color toner C.

The thus obtained magnetic color toner C had an average particle diameter of 10.1 μm; a dispersibility of the rank 5; an L* value of 40.41; an a* value of 3.64; a b* value of 43.22; a C* value of 43.37; a light resistance (ΔE* value) of 3.43; a coercive force value of 8.0 kA/m (101 Oe); a saturation magnetization value in a magnetic field of 795.8 kA/m (10 kOe) of 6.4 Am²/kg (6.4 emu/g); and a saturation magnetization value in a magnetic field of 79.6 kA/m (1 kOe) of 3.8 Am²/kg (3.8 emu/g).

### Example 7

### Developing Method 1

The magnetic color toners A to C respectively obtained in Examples 4 to 6 were used as developers to form toner images as follows, and the thus formed toner images were evaluated. First, a negative charge polarity-type drum-shaped photosensitive member was electrified, and then subjected to divided light exposure by a semiconductor laser, thereby forming an electrostatic image on the surface thereof. The thus formed electrostatic image was developed using a developing device including a permanent magnet roll and a sleeve made of stainless steel. After completion of the development, the developed image was transferred onto a plain paper using a corona transferring device, and then fixed thereon by using a heated roll and a silicone rubber roll, thereby obtaining a toner image.

Among the thus obtained toner images, the image obtained using the magnetic color toner A had an image density of 1.24, an image durability of 3.32% and an image fogging (ΔL* value) of 2.18; the image obtained using the magnetic color toner B had an image density of 1.23, an image durability of 3.39% and an image fogging (ΔL* value) of 2.20; and the image obtained using the magnetic color toner C had an image density of 1.23, an image durability of 3.41% and an image fogging (ΔL* value) of 2.21.

### Example 8

### Developing Method 2

The magnetic color toners A to C respectively obtained in Examples 4 to 6 were used as developers to form toner images as follows, and the thus formed toner images were evaluated. First, a negative charge polarity-type drum-shaped photosensitive member was electrified, and then subjected to divided light exposure by a semiconductor laser, thereby forming an electrostatic image on the surface thereof. The thus formed electrostatic image was developed using a developing device including a permanent magnet roll and a sleeve made of stainless steel. Meanwhile, a bias voltage was applied to the sleeve. After completion of the development, the developed image was transferred onto a plain paper using a corona transferring device, and then fixed thereon by using a heated roll and a silicone rubber roll, thereby obtaining a toner image.

Among the thus obtained toner images, the image obtained using the magnetic color toner A had an image density of 1.26, an image durability of 3.10% and an image fogging (ΔL* value) of 2.11; the image obtained using the magnetic color toner B had an image density of 1.25, an image durability of 3.18% and an image fogging (ΔL* value) of 2.14; and the image obtained using the magnetic color toner C had an image density of 1.24, an image durability of 3.22% and an image fogging (ΔL* value) of 2.15.

### Example 9

### Developing Method 3

The magnetic color toners A to C respectively obtained in Examples 4 to 6 were mixed with ferrite carrier to prepare developers. The thus prepared developers were used to form toner images as follows, and the toner images thus formed were evaluated. First, a negative charge polarity-type drum-shaped photosensitive member was electrified, and then subjected to divided light exposure by a semiconductor laser, thereby forming an electrostatic image on the surface thereof. The thus formed electrostatic image was developed using a developing device including a permanent magnet roll and a sleeve made of stainless steel. After completion of the development, the developed image was transferred onto a plain paper using a corona transferring device, and then fixed thereon by using a heated roll and a silicone rubber roll, thereby obtaining a toner image.

Among the thus obtained toner images, the image obtained using the magnetic color toner A had an image density of 1.28, an image durability of 2.82% and an image fogging (ΔL* value) of 1.79; the image obtained using the magnetic color toner B had an image density of 1.26, an image durability of 2.91% and an image fogging (ΔL* value) of 1.81; and the image obtained using the magnetic color toner C had an image density of 1.25, an image durability of 3.00% and an image fogging (ΔL* value) of 1.82.

### Example 10

### Developing Method 4

The magnetic color toners A to C respectively obtained in Examples 4 to 6 were mixed with ferrite carrier to prepare developers. The thus prepared developers were used to form toner images as follows, and the toner images thus formed were evaluated. First, a negative charge polarity-type drum-shaped photosensitive member was electrified, and then subjected to divided light exposure by a semiconductor laser, thereby forming an electrostatic image on the surface thereof. The thus formed electrostatic image was developed using a developing device including a permanent magnet roll and a sleeve made of stainless steel. Meanwhile, a bias voltage was applied to the sleeve. After completion of the development, the developed image was transferred onto a plain paper using a corona transferring device, and then fixed thereon by using a heated roll and a silicone rubber roll, thereby obtaining a toner image.

Among the thus obtained toner images, the image obtained using the magnetic color toner A had an image density of 1.29, an image durability of 2.74% and an image fogging (ΔL* value) of 1.64; the image obtained using the magnetic color toner B had an image density of 1.28, an image durability of 2.81% and an image fogging (ΔL* value) of 1.71; and the image obtained using the magnetic color toner C had an image density of 1.28, an image durability of 2.84% and an image fogging (ΔL* value) of 1.78.

Magnetic Particles 1 to 3:

Magnetic particles 1 to 3 having properties shown in Table 1 were prepared.

Magnetic Particles 4:

20 kg of octahedral magnetite particles as deagglomerated magnetic particles 1 were dispersed in 150 liters of water to obtain a slurry containing the octahedral magnetite particles, by the same method as defined in Example 1. The pH value of the thus obtained re-dispersed slurry containing the octahedral magnetite particles was adjusted to 10.5 by using an aqueous sodium hydroxide solution. Then, water was added to the slurry to adjust the slurry concentration to 98 g/liter. 150 liters of the slurry was heated to 60° C., and 5,444 ml of a 1.0 mol/l NaAlO₂ solution (corresponding to 1.0% by weight (calculated as Al) based on the weight of the octahedral magnetite particles) was added to the slurry. After holding the slurry for 30 minutes, the pH value of the slurry was adjusted to 7.5 by using acetic acid. Next, after adding 139 g of water glass #3 (corresponding to 0.2% by weight (calculated as SiO₂) based on the weight of the octahedral magnetite particles) to the slurry, the resultant slurry was aged for 30 minutes, and the pH value thereof was adjusted to 7.5 by using acetic acid. After holding the slurry for 30 minutes, the slurry was subjected to filtration, washing with water, drying and pulverization, thereby obtaining octahedral magnetite particles coated with an undercoating material composed of hydroxides of aluminum and oxides of silicon.

The essential production conditions are shown in Table 2, and various properties of the obtained surface-treated magnetic particles are shown in Table 3.

Magnetic Particles 5 and 6:

The same procedure as defined for the above production of magnetic particles 4 was conducted except that magnetic particles 2 and 3 were used instead of magnetic particles 1, and kinds and amounts of undercoating materials were changed variously, thereby obtaining magnetic particles coated with the undercoating materials.

The essential production conditions are shown in Table 2, and various properties of the obtained surface-treated magnetic particles are shown in Table 3. Meanwhile, in “Kind of undercoating material” in “Surface-treating step” in Tables, “A” represents hydroxides of aluminum, and “S” represents oxides of silicon.

Organic Pigments A to C:

Organic pigments A to C having properties as shown in Table 4 were prepared.

### Examples 11 to 28, 53 and 54, and Comparative Examples 1 to 5

The same procedures as defined in Examples 1 to 3 were conducted except that kinds and amounts of gluing agents added in gluing agent coating step, linear load and treating time for edge runner treatment used in the gluing agent coating step, kinds and amounts of organic pigments adhered in organic pigment-adhering step, and linear load and treating time for edge runner treatment used in the organic pigment-adhering step, were changed variously, thereby obtaining magnetic composite particles.

The essential production conditions are shown in Tables 5 and 6, and various properties of the obtained magnetic composite particles are shown in Tables 7 and 8.

### Comparative Example 6

### Example 2 of Japanese Patent Application Laid-Open (KOKAI) No. 60-26954(1985)

10 parts by weight of dehydrated benzene was added to 2 parts by weight of an aminosilane coupling agent (N-β-monoalkylaminoethyl-γ-alkylaminopropyl-alkyl-dimethoxysilane). After intimately mixing the obtained mixture, 100 parts by weight of magnetic particles 1, and 3 parts by weight of blue-based pigments (miarcon blue) were added thereto and mixed together using a mixer. The resultant mixture was dried under vacuum to evaporate benzene therefrom, thereby obtaining magnetic particles coated with the blue-based pigments.

### Comparative Example 7

### Example 2 of Japanese Patent Application Laid-Open (KOKAI) No. 60-26954(1985)

10 parts by weight of dehydrated benzene was added to 2 parts by weight of an aminosilane coupling agent (N-β-monoalkylaminoethyl-γ-alkylaminopropyl-alkyl-dimethoxysilane). After intimately mixing the obtained mixture, 100 parts by weight of magnetic particles 1, and 3 parts by weight of red-based pigments (lake red) were added thereto and mixed together using a mixer. The resultant mixture was dried under vacuum to evaporate benzene therefrom, thereby obtaining magnetic particles coated with the red-based pigments.

### Comparative Example 8

### Example 2 of Japanese Patent Application Laid-Open (KOKAI) No. 60-26954(1985)

10 parts by weight of dehydrated benzene was added to 2 parts by weight of an aminosilane coupling agent (N-β-monoalkylaminoethyl-γ-alkylaminopropyl-alkyl-dimethoxysilane). After intimately mixing the obtained mixture, 100 parts by weight of magnetic particles 1, and 3 parts by weight of yellow-based pigments (benzidine yellow) were added thereto and mixed together using a mixer. The resultant mixture was dried under vacuum to evaporate benzene therefrom, thereby obtaining magnetic particles coated with the yellow-based pigments.

### Comparative Example 9

### Examples of Japanese Patent Application Laid-Open (KOKAI) No. 11-84720(1999)

Magnetic particles 1 were placed in a coating apparatus, and hexamethyldisiloxane in a gaseous state was introduced into the reaction chamber maintained under reduced pressure to generate a high-frequency plasma and form a plasma-polymerization film of hexamethyldisiloxane on the surface of the magnetic particles 1, thereby obtaining magnetic particles having a white coating layer.

Various properties of the magnetic particles obtained in Comparative Examples 6 to 9 are shown in Table 8.

### Examples 29 to 46 and Comparative Examples 10 to 26

The same procedures as defined in Examples 4 to 6 were conducted except that kinds and amounts of magnetic composite particles, kinds and amounts of colorants, and kinds and amounts of binder resins were changed variously, thereby obtaining magnetic color toners.

The essential production conditions are shown in Tables 9 and 10, and various properties of the obtained magnetic color toners are shown in Tables 11 and 12.

### Examples 47 to 52 and Comparative Examples 27 and 28

The same procedures as defined in Examples 7 to 10 were conducted except that types of developing methods and kinds of magnetic color toners were changed variously, thereby forming images.

The essential image forming conditions and various properties of the obtained images are shown in Table 13.

TABLE 1

| | Properties of magnetic particles | |
|---|---|---|
| Magnetic particles | Kind | Shape |
| Magnetic particles 1 | Magnetite | Octahedral |
| Magnetic particles 2 | Iron particles | Spherical |
| Magnetic particles 3 | Mn—Zn ferrite | Granular |

| | Properties of magnetic particles | | |
|---|---|---|---|
| | Average | | |
| | particle | | |
| | diameter | Geometrical | BET specific |
| | (average major | standard | surface area |
| Magnetic | axis diameter) | deviation value | value |
| particles | (μm) | (−) | (m²/g) |
| Magnetic | 0.10 | 1.46 | 15.7 |
| particles 1 | | | |
| Magnetic | 2.13 | 1.78 | 1.6 |
| particles 2 | | | |
| Magnetic | 1.64 | 2.15 | 3.3 |
| particles 3 | | | |

| | Properties of magnetic particles | | |
|---|---|---|---|
| | Magnetic properties | | |
| | | | Saturation |
| | | | magnetization |
| Magnetic | Coercive force value | | value¹⁾ |
| particles | (kA/m) | (Oe) | (Am²/kg) |
| Magnetic | 7.4 | 93 | 85.3 |
| particles 1 | | | |
| Magnetic | 40.4 | 508 | 128.1 |
| particles 2 | | | |
| Magnetic | 141.7 | 1,780 | 54.3 |
| particles 3 | | | |

| | Properties of magnetic particles | | | |
|---|---|---|---|---|
| | | Hue | | |
| Magnetic | Hiding power | L* value | a* value | b* value |
| particles | (cm²/g) | (−) | (−) | (−) |
| Magnetic | 2,100 | 23.64 | 2.14 | 1.64 |
| particles 1 | | | | |
| Magnetic | 1,400 | 38.21 | 1.69 | 2.16 |
| particles 2 | | | | |
| Magnetic | 1,200 | 33.61 | 8.16 | −2.41 |
| particles 3 | | | | |

Note
¹⁾Values measured in a magnetic field of 795.8 kA/m (10 kOe)

TABLE 2

| | | Surface-treating step | | |
|---|---|---|---|---|
| | Kind of | Additives | | |
| Magnetic | magnetic | | Calculated | Amount |
| particles | particles | Kind | as | (wt. %) |
| Magnetic | Magnetic | Sodium | Al | 1.0 |
| particles 4 | particles 1 | aluminate | SiO₂ | 0.2 |
| | | Water | | |
| | | glass #3 | | |
| Magnetic | Magnetic | Water | SiO₂ | 0.5 |
| particles 5 | particles 2 | glass #3 | | |
| Magnetic | Magnetic | Aluminum | Al | 5.0 |
| particles 6 | particles 3 | sulfate | | |

| | Surface-treating step | | |
|---|---|---|---|
| | Undercoating material | | |
| Magnetic | | Calculated | Amount |
| particles | Kind | as | (wt. %) |
| Magnetic | A | Al | 0.98 |
| particles 4 | S | SiO₂ | 0.19 |
| Magnetic | S | SiO₂ | 0.48 |
| particles 5 | | | |
| Magnetic | A | Al | 4.76 |
| particles 6 | | | |

TABLE 3

| | Properties of surface-treated magnetic particles | | |
|---|---|---|---|
| | Average | | |
| | particle | | |
| | diameter | Geometrical | BET specific |
| | (average major | standard | surface area |
| Magnetic | axis diameter) | deviation value | value |
| particles | (μm) | (−) | (m²/g) |
| Magnetic | 0.10 | 1.46 | 15.5 |
| particles 4 | | | |
| Magnetic | 2.13 | 1.78 | 2.1 |
| particles 5 | | | |
| Magnetic | 1.65 | 2.15 | 3.5 |
| particles 6 | | | |

| | Properties of surface-treated magnetic particles | | |
|---|---|---|---|
| | Magnetic properties | | |
| | | | Saturation |
| | | | magnetization |
| Magnetic | Coercive force value | | value¹⁾ |
| particles | (kA/m) | (Oe) | (Am²/kg) |
| Magnetic | 7.5 | 94 | 84.1 |
| particles 4 | | | |
| Magnetic | 40.8 | 513 | 126.4 |
| particles 5 | | | |
| Magnetic | 141.9 | 1,783 | 53.9 |
| particles 6 | | | |

| | Properties of surface-treated magnetic particles | | | |
|---|---|---|---|---|
| | | Hue | | |
| Magnetic | Hiding power | L* value | a* value | b* value |
| particles | (cm²/g) | (−) | (−) | (−) |
| Magnetic | 2,080 | 23.65 | 2.13 | 1.66 |
| particles 4 | | | | |
| Magnetic | 1,360 | 38.19 | 1.67 | 2.14 |
| particles 5 | | | | |
| Magnetic | 1,110 | 33.46 | 8.03 | −1.68 |
| particles 6 | | | | |

Note
¹⁾Values measured in a magnetic field of 795.8 kA/m (10 kOe)

TABLE 4

| Organic | Properties of organic pigments | |
|---|---|---|
| pigments | Kind | Shape |
| Organic | Pigment Blue | Granular |
| pigments A | (phthalocyanine-based | |
| | pigments) | |
| Organic | Pigment Red | Granular |
| pigments B | (azo-based pigments) | |
| Organic | Pigment Yellow | Granular |
| pigments C | (azo-based pigments) | |

| | Properties of organic pigments | |
|---|---|---|
| | Average particle | BET specific surface |
| Organic | diameter | area value |
| pigments | (μm) | (m²/g) |
| Organic | 0.06 | 71.6 |
| pigments A | | |
| Organic | 0.55 | 18.6 |
| pigments B | | |
| Organic | 0.73 | 10.5 |
| pigments C | | |

| | Properties of organic pigments | | | |
|---|---|---|---|---|
| | | | | Light |
| | Hue | | | resistance |
| Organic | L* value | a* value | b* value | (ΔE* value) |
| pigments | (−) | (−) | (−) | (−) |
| Organic | 17.70 | 9.72 | −23.44 | 10.84 |
| pigments A | | | | |
| Organic | 39.31 | 49.18 | 19.77 | 18.60 |
| pigments B | | | | |
| Organic | 66.80 | 0.78 | 70.92 | 17.33 |
| pigments C | | | | |

TABLE 5

| Examples | Kind of magnetic particles |
|---|---|
| Example 11 | Magnetic particles 1 |
| Example 12 | Magnetic particles 1 |
| Example 13 | Magnetic particles 1 |
| Example 14 | Magnetic particles 2 |
| Example 15 | Magnetic particles 2 |
| Example 16 | Magnetic particles 2 |
| Example 17 | Magnetic particles 3 |
| Example 18 | Magnetic particles 3 |
| Example 19 | Magnetic particles 3 |
| Example 20 | Magnetic particles 4 |
| Example 21 | Magnetic particles 4 |
| Example 22 | Magnetic particles 4 |
| Example 23 | Magnetic particles 5 |
| Example 24 | Magnetic particles 5 |
| Example 25 | Magnetic particles 5 |
| Example 26 | Magnetic particles 6 |
| Example 27 | Magnetic particles 6 |
| Example 28 | Magnetic particles 6 |
| Example 53 | Magnetic particles of Example 1 |
| Example 54 | Magnetic particles 1 |

| | Production of magnetic composite particles | |
|---|---|---|
| | Coating step with gluing agent | |
| | Additives | |
| | | Amount |
| | | added |
| Examples | Kind | (wt. part) |
| Example 11 | Methyl triethoxysilane | 1.0 |
| Example 12 | Methyl triethoxysilane | 1.0 |
| Example 13 | Methyl triethoxysilane | 1.0 |
| Example 14 | Phenyl triethoxysilane | 1.5 |
| Example 15 | Phenyl triethoxysilane | 1.5 |
| Example 16 | Phenyl triethoxysilane | 1.5 |
| Example 17 | Methyl hydrogen polysiloxane | 2.0 |
| Example 18 | Methyl hydrogen polysiloxane | 2.0 |
| Example 19 | Methyl hydrogen polysiloxane | 2.0 |
| Example 20 | Dimethyl dimethoxysilane | 4.0 |
| Example 21 | Dimethyl dimethoxysilane | 4.0 |
| Example 22 | Dimethyl dimethoxysilane | 4.0 |
| Example 23 | Methyl hydrogen polysiloxane | 1.0 |
| Example 24 | Methyl hydrogen polysiloxane | 1.0 |
| Example 25 | Methyl hydrogen polysiloxane | 1.0 |
| Example 26 | Methyl triethoxysilane | 2.0 |
| Example 27 | Methyl triethoxysilane | 2.0 |
| Example 28 | Methyl triethoxysilane | 2.0 |
| Example 53 | Methyl triethoxysilane | 2.5 |
| Example 54 | Methyl hydrogen polysiloxane | 3.0 |

| | Production of magnetic composite particles | | | |
|---|---|---|---|---|
| | Coating step with gluing agent | | | |
| | | | | Coating amount |
| | Edge runner treatment | | | (calculated |
| | Linear load | | Time | as C) |
| Examples | (N/cm) | (Kg/cm) | (min.) | (wt. %) |
| Example 11 | 588 | 60 | 30 | 0.07 |
| Example 12 | 588 | 60 | 30 | 0.07 |
| Example 13 | 588 | 60 | 30 | 0.07 |
| Example 14 | 441 | 45 | 45 | 0.53 |
| Example 15 | 441 | 45 | 45 | 0.53 |
| Example 16 | 441 | 45 | 45 | 0.53 |
| Example 17 | 735 | 75 | 30 | 0.53 |
| Example 18 | 735 | 75 | 30 | 0.53 |
| Example 19 | 735 | 75 | 30 | 0.53 |
| Example 20 | 294 | 30 | 60 | 0.52 |
| Example 21 | 294 | 30 | 60 | 0.52 |
| Example 22 | 294 | 30 | 60 | 0.52 |
| Example 23 | 588 | 60 | 20 | 0.26 |
| Example 24 | 588 | 60 | 20 | 0.26 |
| Example 25 | 588 | 60 | 20 | 0.26 |
| Example 26 | 784 | 80 | 20 | 0.13 |
| Example 27 | 784 | 80 | 20 | 0.13 |
| Example 28 | 784 | 80 | 20 | 0.13 |
| Example 53 | 588 | 60 | 45 | 0.16 |
| Example 54 | 735 | 75 | 60 | 0.79 |

| | Production of magnetic | |
|---|---|---|
| | composite particles | |
| | Adhesion step with organic pigments | |
| | Organic pigments | |
| | | Amount adhered |
| Examples | Kind | (wt. part) |
| Example 11 | A | 50.0 |
| Example 12 | B | 50.0 |
| Example 13 | C | 50.0 |
| Example 14 | A | 10.0 |
| Example 15 | B | 10.0 |
| Example 16 | C | 10.0 |
| Example 17 | A | 5.0 |
| Example 18 | B | 5.0 |
| Example 19 | C | 5.0 |
| Example 20 | A | 20.0 |
| Example 21 | B | 20.0 |
| Example 22 | C | 20.0 |
| Example 23 | A | 15.0 |
| Example 24 | B | 15.0 |
| Example 25 | C | 15.0 |
| Example 26 | A | 80.0 |
| Example 27 | B | 80.0 |
| Example 28 | C | 80.0 |
| Example 53 | A | 60.0 |
| Example 54 | A | 100.0 |

| | Production of magnetic composite particles | | | |
|---|---|---|---|---|
| | Adhesion step with organic pigments | | | |
| | | | | Amount adhered |
| | Edge runner treatment | | | (calculated |
| | Linear load | | Time | as C) |
| Examples | (N/cm) | (Kg/cm) | (min.) | (wt. %) |
| Example 11 | 588 | 60 | 90 | 22.08 |
| Example 12 | 588 | 60 | 90 | 19.30 |
| Example 13 | 588 | 60 | 90 | 17.64 |
| Example 14 | 588 | 60 | 60 | 5.95 |
| Example 15 | 588 | 60 | 60 | 5.16 |
| Example 16 | 588 | 60 | 60 | 4.68 |
| Example 17 | 441 | 45 | 40 | 3.11 |
| Example 18 | 441 | 45 | 40 | 2.63 |
| Example 19 | 441 | 45 | 40 | 2.36 |
| Example 20 | 588 | 60 | 60 | 11.02 |
| Example 21 | 588 | 60 | 60 | 9.59 |
| Example 22 | 588 | 60 | 60 | 8.71 |
| Example 23 | 441 | 45 | 60 | 8.54 |
| Example 24 | 441 | 45 | 60 | 7.50 |
| Example 25 | 441 | 45 | 60 | 6.79 |
| Example 26 | 588 | 60 | 120 | 29.43 |
| Example 27 | 588 | 60 | 120 | 25.76 |
| Example 28 | 588 | 60 | 120 | 23.52 |
| Example 53 | 588 | 60 | 90 | 24.86 |
| Example 54 | 588 | 60 | 120 | 33.25 |

TABLE 6

| Comparative | |
|---|---|
| Examples | Kind of magnetic particles |
| Comparative | Magnetic particles 1 |
| Example 1 | |
| Comparative | Magnetic particles 1 |
| Example 2 | |
| Comparative | Magnetic particles 1 |
| Example 3 | |
| Comparative | Magnetic particles 1 |
| Example 4 | |
| Comparative | Magnetic particles 1 |
| Example 5 | |

| | Production of magnetic composite particles | |
|---|---|---|
| | Coating step with gluing agent | |
| | Additives | |
| | | Amount |
| Comparative | | added |
| Examples | Kind | (wt. part) |
| Comparative | — | — |
| Example 1 | | |
| Comparative | — | — |
| Example 2 | | |
| Comparative | — | — |
| Example 3 | | |
| Comparative | Methyl triethoxysilane | 1.0 |
| Example 4 | | |
| Comparative | Methyl triethoxysilane | 1.0 |
| Example 5 | | |

| | Production of magnetic composite particles | | | |
|---|---|---|---|---|
| | Coating step with gluing agent | | | |
| | | | | Coating amount |
| | Edge runner treatment | | | (calculated |
| Comparative | Linear load | | Time | as C) |
| Examples | (N/cm) | (Kg/cm) | (min.) | (wt. %) |
| Comparative | — | — | — | — |
| Example 1 | | | | |
| Comparative | — | — | — | — |
| Example 2 | | | | |
| Comparative | — | — | — | — |
| Example 3 | | | | |
| Comparative | 588 | 60 | 30 | 0.07 |
| Example 4 | | | | |
| Comparative | 588 | 60 | 30 | 0.07 |
| Example 5 | | | | |

| | Production of magnetic | |
|---|---|---|
| | composite particles | |
| | Adhesion step with organic pigments | |
| | Organic pigments | |
| Comparative | | Amount adhered |
| Examples | Kind | (wt. part) |
| Comparative | A | 50.0 |
| Example 1 | | |
| Comparative | B | 50.0 |
| Example 2 | | |
| Comparative | C | 50.0 |
| Example 3 | | |
| Comparative | A | 0.5 |
| Example 4 | | |
| Comparative | A | 250.0 |
| Example 5 | | |

| | Production of magnetic composite particles | | | |
|---|---|---|---|---|
| | Adhesion step with organic pigments | | | |
| | | | | Amount adhered |
| | Edge runner treatment | | | (calculated |
| Comparative | Linear load | | Time | as C) |
| Examples | (N/cm) | (Kg/cm) | (min.) | (wt. %) |
| Comparative | 588 | 60 | 90 | 22.07 |
| Example 1 | | | | |
| Comparative | 588 | 60 | 90 | 19.28 |
| Example 2 | | | | |
| Comparative | 588 | 60 | 90 | 17.60 |
| Example 3 | | | | |
| Comparative | 588 | 60 | 90 | 0.30 |
| Example 4 | | | | |
| Comparative | 588 | 60 | 90 | 47.39 |
| Example 5 | | | | |

TABLE 7

| | Properties of magnetic composite particles | | |
|---|---|---|---|
| | Average | | |
| | particle | | |
| | diameter | Geometrical | BET specific |
| | (average major | standard | surface area |
| | axis diameter) | deviation value | value |
| Examples | (μm) | − | (m²/g) |
| Example 11 | 0.11 | 1.47 | 18.3 |
| Example 12 | 0.11 | 1.46 | 21.6 |
| Example 13 | 0.11 | 1.47 | 17.6 |
| Example 14 | 2.13 | 1.78 | 9.3 |
| Example 15 | 2.13 | 1.79 | 8.7 |
| Example 16 | 2.13 | 1.78 | 9.6 |
| Example 17 | 1.64 | 2.15 | 7.3 |
| Example 18 | 1.64 | 2.16 | 8.1 |
| Example 19 | 1.64 | 2.16 | 7.6 |
| Example 20 | 0.10 | 1.47 | 17.1 |
| Example 21 | 0.10 | 1.46 | 18.0 |
| Example 22 | 0.10 | 1.46 | 17.6 |
| Example 23 | 2.13 | 1.78 | 9.0 |
| Example 24 | 2.13 | 1.78 | 8.6 |
| Example 25 | 2.13 | 1.79 | 9.0 |
| Example 26 | 1.66 | 2.16 | 6.8 |
| Example 27 | 1.66 | 2.16 | 6.3 |
| Example 28 | 1.66 | 2.16 | 6.8 |
| Example 53 | 0.14 | 1.46 | 19.5 |
| Example 54 | 0.11 | 1.47 | 21.9 |

| | Properties of magnetic composite particles | | |
|---|---|---|---|
| | Magnetic properties | | |
| | | | Saturation |
| | | | magnetization |
| | Coercive force value | | value¹⁾ |
| Examples | (kA/m) | (Oe) | (Am²/kg) |
| Example 11 | 7.5 | 94 | 65.6 |
| Example 12 | 7.4 | 93 | 66.1 |
| Example 13 | 7.5 | 94 | 64.9 |
| Example 14 | 39.5 | 496 | 118.3 |
| Example 15 | 39.6 | 498 | 117.6 |
| Example 16 | 39.9 | 501 | 117.9 |
| Example 17 | 140.7 | 1,768 | 52.3 |
| Example 18 | 140.5 | 1,765 | 51.8 |
| Example 19 | 140.9 | 1,770 | 51.9 |
| Example 20 | 7.5 | 94 | 72.1 |
| Example 21 | 7.5 | 94 | 71.9 |
| Example 22 | 7.6 | 96 | 72.4 |
| Example 23 | 39.9 | 501 | 112.5 |
| Example 24 | 40.0 | 503 | 111.9 |
| Example 25 | 40.3 | 506 | 112.1 |
| Example 26 | 141.5 | 1,778 | 45.5 |
| Example 27 | 141.7 | 1,781 | 45.7 |
| Example 28 | 140.8 | 1,769 | 45.8 |
| Example 53 | 7.9 | 99 | 62.4 |
| Example 54 | 7.4 | 93 | 61.8 |

| | Properties of magnetic composite particles | | | |
|---|---|---|---|---|
| | | Hue | | |
| | Hiding power | L* value | a* value | b* value |
| Examples | (cm²/g) | (−) | (−) | (−) |
| Example 11 | 2,080 | 21.63 | −0.16 | −1.32 |
| Example 12 | 1,960 | 28.16 | 8.63 | 5.14 |
| Example 13 | 1,930 | 30.83 | 2.14 | 11.42 |
| Example 14 | 1,220 | 31.54 | −1.15 | −1.01 |
| Example 15 | 1,200 | 38.31 | 11.63 | 4.58 |
| Example 16 | 1,190 | 36.12 | 2.34 | 10.67 |
| Example 17 | 1,180 | 28.34 | 4.63 | −4.05 |
| Example 18 | 1,160 | 36.93 | 15.32 | 4.65 |
| Example 19 | 1,150 | 35.42 | 5.26 | 8.63 |
| Example 20 | 2,030 | 21.96 | −0.11 | −1.25 |
| Example 21 | 1,940 | 27.65 | 8.38 | 5.14 |
| Example 22 | 1,910 | 29.81 | 2.68 | 11.17 |
| Example 23 | 1,220 | 32.36 | −1.17 | −1.16 |
| Example 24 | 1,190 | 39.66 | 12.64 | 5.15 |
| Example 25 | 1,180 | 39.38 | 2.65 | 12.13 |
| Example 26 | 1,170 | 25.17 | 4.65 | −3.28 |
| Example 27 | 1,150 | 37.26 | 17.32 | 5.14 |
| Example 28 | 1,140 | 40.48 | 5.13 | 12.48 |
| Example 53 | 1,890 | 22.97 | −0.11 | −1.31 |
| Example 54 | 1,970 | 21.04 | −0.08 | −1.66 |

| | Properties of magnetic composite particles | |
|---|---|---|
| | Light resistance | Desorption percentage |
| | (ΔE* value) | of organic pigments |
| Examples | (−) | (%) |
| Example 11 | 2.51 | 8.2 |
| Example 12 | 3.43 | 8.5 |
| Example 13 | 3.56 | 8.6 |
| Example 14 | 3.64 | 6.1 |
| Example 15 | 3.86 | 6.3 |
| Example 16 | 3.98 | 6.4 |
| Example 17 | 2.66 | 5.9 |
| Example 18 | 2.96 | 5.9 |
| Example 19 | 3.11 | 6.3 |
| Example 20 | 2.33 | 3.1 |
| Example 21 | 3.03 | 3.4 |
| Example 22 | 3.16 | 3.6 |
| Example 23 | 3.38 | 3.3 |
| Example 24 | 3.66 | 3.6 |
| Example 25 | 3.71 | 3.6 |
| Example 26 | 2.56 | 4.4 |
| Example 27 | 2.78 | 4.8 |
| Example 28 | 3.01 | 4.6 |
| Example 53 | 2.60 | 8.5 |
| Example 54 | 2.44 | 9.0 |

Note
¹⁾Values measured in a magnetic field of 795.8 kA/m (10 kOe)

TABLE 8

| | Properties of magnetic composite particles | | |
|---|---|---|---|
| | Average | | |
| | particle | | |
| | diameter | Geometrical | BET specific |
| | (average major | standard | surface area |
| Comparative | axis diameter) | deviation value | value |
| Examples | (μm) | (−) | (m²/g) |
| Comparative | 0.10 | — | 22.7 |
| Example 1 | | | |
| Comparative | 0.10 | — | 16.3 |
| Example 2 | | | |
| Comparative | 0.10 | — | 15.6 |
| Example 3 | | | |
| Comparative | 0.10 | 1.46 | 15.3 |
| Example 4 | | | |
| Comparative | 0.11 | — | 58.3 |
| Example 5 | | | |
| Comparative | 0.10 | 1.46 | 16.8 |
| Example 6 | | | |
| Comparative | 0.10 | 1.47 | 16.4 |
| Example 7 | | | |
| Comparative | 0.10 | 1.47 | 17.2 |
| Example 8 | | | |
| Comparative | 0.10 | 1.46 | 10.9 |
| Example 9 | | | |

| | Properties of magnetic composite particles | | |
|---|---|---|---|
| | Magnetic properties | | |
| | | | Saturation |
| | | | magnetization |
| Comparative | Coercive force value | | value¹⁾ |
| Examples | (kA/m) | (Oe) | (Am²/ kg) |
| Comparative | 7.6 | 96 | 77.4 |
| Example 1 | | | |
| Comparative | 7.5 | 94 | 76.2 |
| Example 2 | | | |
| Comparative | 7.6 | 96 | 77.3 |
| Example 3 | | | |
| Comparative | 7.8 | 98 | 83.6 |
| Example 4 | | | |
| Comparative | 7.6 | 95 | 26.8 |
| Example 5 | | | |
| Comparative | 7.6 | 96 | 80.2 |
| Example 6 | | | |
| Comparative | 7.6 | 96 | 80.0 |
| Example 7 | | | |
| Comparative | 7.6 | 96 | 80.3 |
| Example 8 | | | |
| Comparative | 7.6 | 95 | 81.5 |
| Example 9 | | | |

| | Properties of magnetic composite particles | | | |
|---|---|---|---|---|
| | | Hue | | |
| Comparative | Hiding power | L* value | a* value | b* value |
| Examples | (cm²/g) | (−) | (−) | (−) |
| Comparative | 2,120 | 21.84 | 0.14 | 0.05 |
| Example 1 | | | | |
| Comparative | 2,110 | 28.33 | 6.92 | 4.68 |
| Example 2 | | | | |
| Comparative | 2,080 | 30.95 | 1.95 | 8.32 |
| Example 3 | | | | |
| Comparative | 2,100 | 22.63 | 2.96 | 0.89 |
| Example 4 | | | | |
| Comparative | 2,380 | 21.62 | 6.36 | −1.57 |
| Example 5 | | | | |
| Comparative | 2,130 | 20.16 | 0.13 | 0.92 |
| Example 6 | | | | |
| Comparative | 2,120 | 30.23 | 5.18 | 3.31 |
| Example 7 | | | | |
| Comparative | 2,140 | 28.54 | 1.60 | 6.61 |
| Example 8 | | | | |
| Comparative | 1,950 | 43.62 | 3.64 | 2.63 |
| Example 9 | | | | |

| | Properties of magnetic composite particles | |
|---|---|---|
| | Light resistance | Desorption percentage |
| Comparative | (ΔE* value) | of organic pigments |
| Examples | (−) | (%) |
| Comparative | 7.61 | 64.3 |
| Example 1 | | |
| Comparative | 9.59 | 67.2 |
| Example 2 | | |
| Comparative | 10.38 | 71.3 |
| Example 3 | | |
| Comparative | 9.52 | 8.9 |
| Example 4 | | |
| Comparative | 7.31 | 40.4 |
| Example 5 | | |
| Comparative | 15.97 | — |
| Example 6 | | |
| Comparative | 17.26 | — |
| Example 7 | | |
| Comparative | 18.83 | — |
| Example 8 | | |
| Comparative | 5.74 | — |
| Example 9 | | |

Note
¹⁾Values measured in a magnetic field of 795.8 kA/m (10 kOe)

TABLE 9

| | Production of magnetic color toner | | | |
|---|---|---|---|---|
| | Magnetic particles | | Colorant | |
| | | Amount | | Amount |
| | | blended | | blended |
| Examples | Kind | (wt. part) | Kind | (wt. part) |
| Example 29 | Example 11 | 20.0 | A | 20.0 |
| Example 30 | Example 12 | 20.0 | B | 20.0 |
| Example 31 | Example 13 | 20.0 | C | 20.0 |
| Example 32 | Example 14 | 10.0 | A | 18.0 |
| Example 33 | Example 15 | 10.0 | B | 18.0 |
| Example 34 | Example 16 | 10.0 | C | 18.0 |
| Example 35 | Example 17 | 10.0 | A | 20.0 |
| Example 36 | Example 18 | 10.0 | B | 20.0 |
| Example 37 | Example 19 | 10.0 | C | 20.0 |
| Example 38 | Example 20 | 7.5 | A | 15.0 |
| Example 39 | Example 21 | 7.5 | B | 15.0 |
| Example 40 | Example 22 | 7.5 | C | 15.0 |
| Example 41 | Example 23 | 5.0 | A | 10.0 |
| Example 42 | Example 24 | 5.0 | B | 10.0 |
| Example 43 | Example 25 | 5.0 | C | 10.0 |
| Example 44 | Example 26 | 10.0 | A | 20.0 |
| Example 45 | Example 27 | 10.0 | B | 20.0 |
| Example 46 | Example 28 | 10.0 | C | 20.0 |

| | Production of magnetic color toner | |
|---|---|---|
| | Binder resin | |
| | | Amount |
| | | blended |
| Examples | Kind | (wt. part) |
| Example 29 | Polyester resin | 90.0 |
| Example 30 | Polyester resin | 90.0 |
| Example 31 | Polyester resin | 90.0 |
| Example 32 | Polyester resin | 85.0 |
| Example 33 | Polyester resin | 85.0 |
| Example 34 | Polyester resin | 85.0 |
| Example 35 | Polyester resin | 85.0 |
| Example 36 | Polyester resin | 85.0 |
| Example 37 | Polyester resin | 85.0 |
| Example 38 | Polyester resin | 85.0 |
| Example 39 | Polyester resin | 85.0 |
| Example 40 | Polyester resin | 85.0 |
| Example 41 | Polyester resin | 85.0 |
| Example 42 | Polyester resin | 85.0 |
| Example 43 | Polyester resin | 85.0 |
| Example 44 | Polyester resin | 85.0 |
| Example 45 | Polyester resin | 85.0 |
| Example 46 | Polyester resin | 85.0 |

Table 10

Production of magnetic color toner
Magnetic particles

| | | Amount |
|---|---|---|
| | | blended |
| Comparative Examples | Kind | (wt. part) |
| Comparative Example 10 | Comparative Example 1 | 10.0 |
| Comparative Example 11 | Comparative Example 2 | 10.0 |
| Comparative Example 12 | Comparative Example 3 | 10.0 |
| Comparative Example 13 | Comparative Example 4 | 10.0 |
| Comparative Example 14 | Comparative Example 5 | 10.0 |
| Comparative Example 15 | Comparative Example 6 | 10.0 |
| Comparative Example 16 | Comparative Example 7 | 10.0 |
| Comparative Example 17 | Comparative Example 8 | 10.0 |
| Comparative Example 18 | Comparative Example 9 | 10.0 |
| Comparative Example 19 | Comparative Example 9 | 10.0 |
| Comparative Example 20 | Comparative Example 9 | 10.0 |
| Comparative Example 21 | Example 11 | 30.0 |
| Comparative Example 22 | Example 12 | 30.0 |
| Comparative Example 23 | Example 13 | 30.0 |
| Comparative Example 24 | Example 11 | 0.5 |
| Comparative Example 25 | Example 12 | 0.5 |
| Comparative Example 26 | Example 13 | 0.5 |

Production of magnetic color toner
Colorant

| | | Amount blended |
|---|---|---|
| Comparative Examples | Kind | (wt. part) |
| Comparative Example 10 | A | 10.0 |
| Comparative Example 11 | B | 10.0 |
| Comparative Example 12 | C | 10.0 |
| Comparative Example 13 | A | 10.0 |
| Comparative Example 14 | A | 10.0 |
| Comparative Example 15 | A | 10.0 |
| Comparative Example 16 | B | 10.0 |
| Comparative Example 17 | C | 10.0 |
| Comparative Example 18 | A | 10.0 |
| Comparative Example 19 | B | 10.0 |
| Comparative Example 20 | C | 10.0 |
| Comparative Example 21 | A | 10.0 |
| Comparative Example 22 | B | 10.0 |
| Comparative Example 23 | C | 10.0 |
| Comparative Example 24 | A | 10.0 |
| Comparative Example 25 | B | 10.0 |
| Comparative Example 26 | C | 10.0 |

Production of magnetic color toner
Binder resin

| | | Amount |
|---|---|---|
| | | blended |
| Comparative Examples | Kind | (wt. part) |
| Comparative Example 10 | Polyester resin | 85.0 |
| Comparative Example 11 | Polyester resin | 85.0 |
| Comparative Example 12 | Polyester resin | 85.0 |
| Comparative Example 13 | Polyester resin | 85.0 |
| Comparative Example 14 | Polyester resin | 85.0 |
| Comparative Example 15 | Polyester resin | 85.0 |
| Comparative Example 16 | Polyester resin | 85.0 |
| Comparative Example 17 | Polyester resin | 85.0 |
| Comparative Example 18 | Polyester resin | 85.0 |
| Comparative Example 19 | Polyester resin | 85.0 |
| Comparative Example 20 | Polyester resin | 85.0 |
| Comparative Example 21 | Polyester resin | 90.0 |
| Comparative Example 22 | Polyester resin | 90.0 |
| Comparative Example 23 | Polyester resin | 90.0 |
| Comparative Example 24 | Polyester resin | 80.0 |
| Comparative Example 25 | Polyester resin | 80.0 |
| Comparative Example 26 | Polyester resin | 80.0 |

TABLE 11

Properties of magnetic color toner

| | Average particle | |
|---|---|---|
| | diameter | Dispersibility |
| Examples | (μm) | (−) |
| Example 29 | 10.5 | 5 |
| Example 30 | 10.3 | 5 |
| Example 31 | 10.5 | 5 |
| Example 32 | 11.0 | 5 |
| Example 33 | 10.8 | 5 |
| Example 34 | 11.0 | 5 |
| Example 35 | 10.2 | 4 |
| Example 36 | 10.6 | 4 |
| Example 37 | 10.8 | 4 |
| Example 38 | 9.9 | 5 |
| Example 39 | 10.3 | 5 |
| Example 40 | 10.6 | 5 |
| Example 41 | 10.8 | 5 |
| Example 42 | 10.3 | 5 |
| Example 43 | 11.1 | 5 |
| Example 44 | 9.8 | 5 |
| Example 45 | 10.5 | 5 |
| Example 46 | 10.5 | 5 |

| | Properties of magnetic color toner | | | |
|---|---|---|---|---|
| | Magnetic properties | | | |
| | | | Saturation | Saturation |
| | Coercive force | | magnetization | magnetization |
| | value | | value¹⁾ | value²⁾ |
| Examples | (kA/m) | (Oe) | (Am²/kg) | (Am²/kg) |
| Example 29 | 7.4 | 93 | 11.8 | 6.8 |
| Example 30 | 7.3 | 92 | 12.1 | 7.3 |
| Example 31 | 7.2 | 91 | 12.6 | 8.1 |
| Example 32 | 38.4 | 483 | 11.1 | 6.8 |
| Example 33 | 39.2 | 492 | 11.6 | 7.1 |
| Example 34 | 39.8 | 500 | 11.5 | 6.5 |
| Example 35 | 139.9 | 1,758 | 5.3 | 3.8 |
| Example 36 | 137.8 | 1,732 | 5.6 | 4.1 |
| Example 37 | 140.1 | 1,760 | 5.7 | 3.8 |
| Example 38 | 7.2 | 90 | 6.1 | 3.9 |
| Example 39 | 7.2 | 91 | 5.8 | 3.8 |
| Example 40 | 7.2 | 90 | 5.8 | 3.7 |
| Example 41 | 39.9 | 501 | 6.1 | 4.1 |
| Example 42 | 39.5 | 496 | 6.3 | 4.1 |
| Example 43 | 39.6 | 498 | 6.1 | 4.1 |
| Example 44 | 139.3 | 1,750 | 4.8 | 3.6 |
| Example 45 | 139.1 | 1,748 | 4.3 | 3.8 |
| Example 46 | 140.3 | 1,763 | 4.2 | 3.6 |

| | Properties of magnetic color toner | | | | |
|---|---|---|---|---|---|
| | | | | | Light |
| | Hue | | | | resistance |
| | L* value | a* value | b* value | C* value | (ΔE* value) |
| Examples | (−) | (−) | (−) | (−) | (−) |
| Example 29 | 21.61 | 8.38 | −18.66 | 20.46 | 2.33 |
| Example 30 | 34.12 | 40.19 | 15.44 | 43.05 | 3.29 |
| Example 31 | 40.83 | 3.93 | 43.31 | 43.49 | 3.41 |
| Example 32 | 22.34 | 8.60 | −18.67 | 20.56 | 3.50 |
| Example 33 | 34.31 | 40.54 | 15.65 | 43.46 | 3.64 |
| Example 34 | 40.22 | 4.11 | 42.68 | 42.88 | 3.77 |
| Example 35 | 22.43 | 8.65 | −18.07 | 20.03 | 2.53 |
| Example 36 | 34.65 | 40.62 | 15.39 | 43.44 | 2.75 |
| Example 37 | 41.36 | 4.32 | 42.66 | 42.88 | 2.99 |
| Example 38 | 22.44 | 8.13 | −18.30 | 20.02 | 2.18 |
| Example 39 | 34.65 | 40.31 | 15.10 | 43.05 | 2.87 |
| Example 40 | 40.66 | 4.34 | 42.67 | 42.89 | 3.01 |
| Example 41 | 22.17 | 8.30 | −18.61 | 20.38 | 3.24 |
| Example 42 | 34.18 | 40.15 | 15.38 | 42.99 | 3.56 |
| Example 43 | 40.60 | 4.16 | 42.62 | 42.82 | 3.62 |
| Example 44 | 22.28 | 8.47 | −18.39 | 20.25 | 2.38 |
| Example 45 | 34.39 | 40.89 | 15.33 | 43.67 | 2.59 |
| Example 46 | 40.40 | 4.12 | 43.21 | 43.41 | 2.88 |

Note:
1): Values measured in a magnetic field of 795.8 kA/m (10 kOe); and
2): Values measured in a magnetic field of 79.58 kA/m (1 kOe)

TABLE 12

Properties of magnetic color toner

| | Average particle | |
|---|---|---|
| | diameter | Dispersibility |
| Comparative Examples | (μm) | (−) |
| Comparative Example 10 | 10.5 | 2 |
| Comparative Example 11 | 10.6 | 2 |
| Comparative Example 12 | 10.7 | 2 |
| Comparative Example 13 | 10.3 | 2 |
| Comparative Example 14 | 10.0 | 2 |
| Comparative Example 15 | 10.6 | 2 |
| Comparative Example 16 | 10.4 | 3 |
| Comparative Example 17 | 10.3 | 3 |
| Comparative Example 18 | 10.6 | 3 |
| Comparative Example 19 | 10.5 | 2 |
| Comparative Example 20 | 10.3 | 2 |
| Comparative Example 21 | 10.5 | 4 |
| Comparative Example 22 | 10.1 | 4 |
| Comparative Example 23 | 10.0 | 4 |
| Comparative Example 24 | 9.9 | 5 |
| Comparative Example 25 | 10.1 | 5 |
| Comparative Example 26 | 10.3 | 5 |

Properties of magnetic color toner
Magnetic properties
Coercive force value

| Comparative Examples | (kA/m) | (Oe) |
|---|---|---|
| Comparative Example 10 | 7.4 | 93 |
| Comparative Example 11 | 7.3 | 92 |
| Comparative Example 12 | 7.2 | 90 |
| Comparative Example 13 | 7.2 | 91 |
| Comparative Example 14 | 7.5 | 94 |
| Comparative Example 15 | 7.6 | 96 |
| Comparative Example 16 | 7.8 | 98 |
| Comparative Example 17 | 7.6 | 96 |
| Comparative Example 18 | 7.6 | 95 |
| Comparative Example 19 | 7.6 | 95 |
| Comparative Example 20 | 7.5 | 94 |
| Comparative Example 21 | 7.3 | 92 |
| Comparative Example 22 | 7.4 | 93 |
| Comparative Example 23 | 7.3 | 92 |
| Comparative Example 24 | 7.1 | 89 |
| Comparative Example 25 | 7.0 | 88 |
| Comparative Example 26 | 6.9 | 87 |

Properties of magnetic color
toner
Magnetic properties

| | Saturation | Saturation |
|---|---|---|
| | magnetization | magnetization |
| | value¹⁾ | value²⁾ |
| Comparative Examples | (Am²/kg) | (Am²/kg) |
| Comparative Example 10 | 6.1 | 3.9 |
| Comparative Example 11 | 5.8 | 3.8 |
| Comparative Example 12 | 6.3 | 3.9 |
| Comparative Example 13 | 5.9 | 3.8 |
| Comparative Example 14 | 6.0 | 4.0 |
| Comparative Example 15 | 5.6 | 3.8 |
| Comparative Example 16 | 5.8 | 3.7 |
| Comparative Example 17 | 6.1 | 3.6 |
| Comparative Example 18 | 6.3 | 3.7 |
| Comparative Example 19 | 6.3 | 3.6 |
| Comparative Example 20 | 6.2 | 3.6 |
| Comparative Example 21 | 18.1 | 10.8 |
| Comparative Example 22 | 18.0 | 10.7 |
| Comparative Example 23 | 17.9 | 10.7 |
| Comparative Example 24 | 0.4 | 0.3 |
| Comparative Example 25 | 0.3 | 0.3 |
| Comparative Example 26 | 0.4 | 0.3 |

Properties of magnetic color toner
Hue

| | L* value | a* value |
|---|---|---|
| Comparative Examples | (−) | (−) |
| Comparative Example 10 | 20.31 | 3.12 |
| Comparative Example 11 | 31.61 | 32.33 |
| Comparative Example 12 | 34.19 | 1.66 |
| Comparative Example 13 | 19.84 | 2.16 |
| Comparative Example 14 | 19.57 | 4.28 |
| Comparative Example 15 | 20.66 | 6.01 |
| Comparative Example 16 | 32.49 | 33.36 |
| Comparative Example 17 | 37.83 | 1.67 |
| Comparative Example 18 | 24.83 | 2.87 |
| Comparative Example 19 | 33.46 | 30.19 |
| Comparative Example 20 | 37.55 | 1.75 |
| Comparative Example 21 | 19.88 | 7.56 |
| Comparative Example 22 | 31.05 | 37.22 |
| Comparative Example 23 | 36.42 | 2.99 |
| Comparative Example 24 | 20.22 | 8.51 |
| Comparative Example 25 | 34.97 | 40.57 |
| Comparative Example 26 | 41.26 | 4.01 |

| | Properties of magnetic color | | |
|---|---|---|---|
| | toner | | |
| | | | Light |
| | Hue | | resistance |
| | b* value | C* value | (ΔE* value) |
| Comparative Examples | (−) | (−) | (−) |
| Comparative Example 10 | −11.61 | 12.02 | 7.55 |
| Comparative Example 11 | 11.44 | 34.29 | 9.42 |
| Comparative Example 12 | 31.61 | 31.65 | 10.19 |
| Comparative Example 13 | −10.62 | 10.84 | 9.33 |
| Comparative Example 14 | −16.59 | 17.13 | 7.24 |
| Comparative Example 15 | −15.93 | 17.03 | 15.15 |
| Comparative Example 16 | 13.14 | 35.85 | 16.43 |
| Comparative Example 17 | 38.76 | 38.80 | 18.02 |
| Comparative Example 18 | −9.25 | 9.69 | 5.57 |
| Comparative Example 19 | 10.38 | 31.92 | 5.61 |
| Comparative Example 20 | 29.17 | 29.22 | 5.66 |
| Comparative Example 21 | −15.54 | 17.28 | 2.31 |
| Comparative Example 22 | 13.26 | 39.51 | 3.27 |
| Comparative Example 23 | 39.86 | 39.97 | 3.40 |
| Comparative Example 24 | −19.71 | 21.47 | 2.36 |
| Comparative Example 25 | 15.62 | 43.47 | 3.32 |
| Comparative Example 26 | 42.88 | 43.07 | 3.45 |

Note:
1): Values measured in a magnetic field of 795.8 kA/m (10 kOe); and
2): Values measured in a magnetic field of 79.58 kA/m (1 kOe)

TABLE 13

Developing method

| Examples and | | Combination of |
|---|---|---|
| Comparative | Kind of developing | magnetic color |
| Examples | method | toners |
| Example 47 | Developing method 1 | Example 29 |
| | | Example 30 |
| | | Example 31 |
| Example 48 | Developing method 2 | Example 32 |
| | | Example 33 |
| | | Example 34 |
| Example 49 | Developing method 3 | Example 35 |
| | | Example 36 |
| | | Example 37 |
| Example 50 | Developing method 4 | Example 38 |
| | | Example 39 |
| | | Example 40 |
| Example 51 | Developing method 1 | Example 41 |
| | | Example 42 |
| | | Example 43 |
| Example 52 | Developing method 3 | Example 44 |
| | | Example 45 |
| | | Example 46 |
| Comparative | Developing method 1 | Comparative |
| Example 19 | | Example 10 |
| | | Comparative |
| | | Example 11 |
| | | Comparative |
| | | Example 12 |
| Comparative | Developing method 1 | Comparative |
| Example 20 | | Example 15 |
| | | Comparative |
| | | Example 16 |
| | | Comparative |
| | | Example 17 |

| | Image properties | | |
|---|---|---|---|
| Examples and | | Image | Image fogging |
| Comparative | Image density | durability | ΔL* value |
| Examples | (−) | (%) | (−) |
| Example 47 | 1.23 | 3.3 | 1.51 |
| | 1.23 | 3.4 | 1.33 |
| | 1.22 | 3.4 | 1.27 |
| Example 48 | 1.28 | 4.1 | 2.42 |
| | 1.27 | 4.2 | 2.34 |
| | 1.26 | 4.3 | 2.83 |
| Example 49 | 1.29 | 4.8 | 1.85 |
| | 1.27 | 4.9 | 1.74 |
| | 1.27 | 4.9 | 1.86 |
| Example 50 | 1.23 | 2.6 | 2.38 |
| | 1.22 | 2.8 | 2.25 |
| | 1.23 | 2.7 | 2.39 |
| Example 51 | 1.24 | 3.8 | 1.60 |
| | 1.22 | 3.9 | 1.66 |
| | 1.23 | 3.9 | 1.61 |
| Example 52 | 1.28 | 2.3 | 0.87 |
| | 1.27 | 2.4 | 0.92 |
| | 1.26 | 2.3 | 0.98 |
| Comparative | 0.96 | 13.6 | 5.83 |
| Example 19 | 0.97 | 13.5 | 6.19 |
| | 0.95 | 13.3 | 6.34 |
| Comparative | 0.89 | 16.8 | 8.60 |
| Example 20 | 0.88 | 16.1 | 8.61 |
| | 0.90 | 17.1 | 8.32 |

What is claimed is:

1. Magnetic composite particles having an average particle diameter of 0.06 to 10.0 μm, comprising:
magnetic particles as core particles,
a gluing agent coating layer formed on surface of said magnetic particles, and
an organic yellow-based pigment coat or an organic red-based pigment coat formed on said gluing agent coating layer in an amount of from 1 to 200 parts by weight based on 100 parts by weight of said magnetic particles.

2. Magnetic composite particles according to claim 1, wherein said gluing agent is at least one organosilicon compound selected from the group consisting of:
(1) organosilane compounds obtainable from alkoxysilane compounds, and
(2) polysiloxanes or modified polysiloxanes.

3. Magnetic composite particles according to claim 1, wherein said magnetic particles as core particles have a coat which is formed on at least a part of the surface of said magnetic particles as core particles and which comprises at least one compound selected from the group consisting of hydroxides of aluminum, oxides of aluminum, hydroxides of silicon and oxides of silicon in an amount of 0.01 to 20% by weight, calculated as Al or SiO₂, based on the total weight of the magnetic particles coated.

4. Magnetic composite particles according to claim 2, wherein said modified polysiloxanes are compounds selected from the group consisting of:
(A) polysiloxanes modified with at least one compound selected from the group consisting of polyethers, polyesters and epoxy compounds, and
(B) polysiloxanes whose molecular terminal is modified with at least one group selected from the group consisting of carboxylic acid groups, alcohol groups and a hydroxyl group.

5. Magnetic composite particles according to claim 2, wherein said alkoxysilane compound is represented by the general formula (I):
R¹ₐSiX₄₋ₐ (I)
wherein R¹ is C₆H₅—, (CH₃)₂CHCH₂— or n-C_{b}H_{2b+1}— (wherein b is an integer of 1 to 18); X is CH₃O— or C₂H₅O—; and a is an integer of 0 to 3.

6. Magnetic composite particles according to claim 1, wherein the amount of said gluing agent is 0.01 to 15.0% by weight, calculated as C, based on the total weight of the gluing agent and the magnetic particles as core particles.

7. Magnetic composite particles according to claim 1, wherein said magnetic composite particles have an average particle diameter of 0.06 to 0.25 μm or 0.35 to 7.5 μm.

8. Magnetic composite particles according to claim 1, wherein said magnetic composite particles have a BET specific surface area value of 0.5 to 100 m²/g.

9. Magnetic composite particles according to claim 1, wherein said magnetic composite particles have a geometrical standard deviation of particle size of 1.01 to 2.5.

10. Magnetic composite particles according to claim 1, wherein said magnetic composite particles have a coercive force value of 0.8 to 159.2 kA/m; a saturation magnetization value in a magnetic field of 795.8 kA/m of 50 to 150 Am²/kg; and a residual magnetization value in a magnetic field of 795.8 kA/m of 1 to 75 Am²/kg.

11. Magnetic composite particles having an average particle diameter of 0.06 to 10.0 μm, comprising:
magnetic particles as core particles,
a gluing agent coating layer formed on surface of said magnetic particles, and
an organic blue-based pigment coat formed on said coating layer comprising said organosilicon compound, in an amount of from more than 50 to 200 parts by weight based on 100 parts by weight of said magnetic particles.

12. Magnetic composite particles according to claim 11, wherein said gluing agent is at least one organosilicon compound selected from the group consisting of:
(1) organosilane compounds obtainable from alkoxysilane compounds, and
(2) polysiloxanes or modified polysiloxanes.

13. Magnetic composite particles according to claim 11, wherein said magnetic particles as core particles have a coat which is formed on at least a part of the surface of said magnetic particles as core particles and which comprises at least one compound selected from the group consisting of hydroxides of aluminum, oxides of aluminum, hydroxides of silicon and oxides of silicon in an amount of 0.01 to 20% by weight, calculated as Al or SiO₂, based on the total weight of the magnetic particles coated.

14. Magnetic composite particles according to claim 12, wherein said modified polysiloxanes are compounds selected from the group consisting of:
(A) polysiloxanes modified with at least one compound selected from the group consisting of polyethers, polyesters and epoxy compounds, and
(B) polysiloxanes whose molecular terminal is modified with at least one group selected from the group consisting of carboxylic acid groups, alcohol groups and a hydroxyl group.

15. Magnetic composite particles according to claim 12, wherein said alkoxysilane compound is represented by the general formula (I):
R¹ₐSiX₄₋ₐ (I)
wherein R¹ is C₆H₅—, (CH₃)₂CHCH₂— or n-C_{b}H_{2b+1}— (wherein b is an integer of 1 to 18); X is CH₃O— or C₂H₅O—; and a is an integer of 0 to 3.

16. Magnetic composite particles according to claim 11, wherein the amount of said gluing agent is 0.01 to 15.0% by weight, calculated as C, based on the total weight of the gluing agent and the magnetic particles as core particles.

17. Magnetic composite particles according to claim 11, wherein said magnetic composite particles have an average particle diameter of 0.06 to 0.25 μm or 0.35 to 7.5 μm.

18. Magnetic composite particles according to claim 11, wherein said magnetic composite particles have a BET specific surface area value of 0.5 to 100 m²/g.

19. Magnetic composite particles according to claim 11, wherein said magnetic composite particles have a geometrical standard deviation of particle size of 1.01 to 2.5.

20. Magnetic composite particles according to claim 11, wherein said magnetic composite particles have a coercive force value of 0.8 to 159.2 kA/m; a saturation magnetization value in a magnetic field of 795.8 kA/m of 50 to 150 Am²/kg; and a residual magnetization value in a magnetic field of 795.8 kA/m of 1 to 75 Am²/kg.

21. Magnetic composite particles having an average particle diameter of 0.06 to 10.0 μm and a geometrical standard deviation of particle size of 1.01 to 2.5, comprising:
magnetic particles as core particles, having a coat formed on at least a part of the surface of said magnetic particles as core particles, comprising at least one compound selected from the group consisting of hydroxides of aluminum, oxides of aluminum, hydroxides of silicon and oxides of silicon in an amount of 0.01 to 20% by weight, calculated as Al or SiO₂, based on the total weight of the magnetic particles coated
a gluing agent coating layer formed on surface of said magnetic particles, and
an organic yellow-based pigment coat or an organic red-based pigment coat formed on said gluing agent coating layer in an amount of from 1 to 200 parts by weight based on 100 parts by weight of said magnetic particles.

22. Magnetic composite particles having an average particle diameter of 0.06 to 10.0 μm and a geometrical standard deviation of major axis diameter of 1.01 to 2.5, comprising:
magnetic particles as core particles, having a coat formed on at least a part of the surface of said magnetic particles as core particles, comprising at least one compound selected from the group consisting of hydroxides of aluminum, oxides of aluminum, hydroxides of silicon and oxides of silicon in an amount of 0.01 to 20% by weight, calculated as Al or SiO₂, based on the total weight of the magnetic particles coated
a gluing agent coating layer formed on surface of said magnetic particles, and
an organic blue-based pigment coat formed on said coating layer comprising said organosilicon compound, in an amount of from more than 50 to 200 parts by weight based on 100 parts by weight of said magnetic particles.

23. Magnetic color toner comprising:
a binder resin, a colorant and
magnetic composite particles having an average particle diameter of 0.06 to 10.0 μm, comprising:
magnetic particles as core particles,
a gluing agent coating layer formed on surface of said magnetic particles, and
an organic yellow-based pigment coat, an organic red- based pigment coat or an organic blue-based pigment coat formed on said gluing agent coating layer in an amount of from 1 to 200 parts by weight based on 100 parts by weight of said magnetic particles.

24. Magnetic color toner according to claim 23, wherein the amount of the magnetic composite particles is 1 to 25% by weight of the magnetic color toner.

25. Magnetic color toner according to claim 23, wherein said magnetic particles as core particles have a coat which is formed on at least a part of the surface of said magnetic particles as core particles and which comprises at least one compound selected from the group consisting of hydroxides of aluminum, oxides of aluminum, hydroxides of silicon and oxides of silicon in an amount of 0.01 to 20% by weight, calculated as Al or SiO₂, based on the total weight of the magnetic particles coated.

26. Magnetic color toner comprising:
(1) an yellow toner comprising a binder resin, an organic yellow-based pigment as a colorant and
magnetic composite particles having an average particle diameter of 0.06 to 10.0 μm, comprising:
magnetic particles as core particles,
a gluing agent coating layer formed on surface of said magnetic particles, and
an organic yellow-based pigment coat formed on said gluing agent coating layer in an amount of from 1 to 200 parts by weight based on 100 parts by weight of said magnetite particles;
(2) a red toner comprising a binder resin, an organic red-based pigment as a colorant and
magnetic composite particles having an average particle diameter of 0.06 to 10.0 μm, comprising:
magnetic particles as core particles,
a gluing agent coating layer formed on surface of said magnetic particles, and
an organic red-based pigment coat formed on said gluing agent coating layer in an amount of from 1 to 200 parts by weight based on 100 parts by weight of said magnetite particles; and
(3) a blue comprising a binder resin, an organic blue-based pigment as a colorant and
magnetic composite particles having an average particle diameter of 0.06 to 10.0 μm, comprising:
magnetic particles as core particles,
a gluing agent coating layer formed on surface of said magnetic particles, and
an organic blue-based pigment coat formed on said gluing agent coating layer in an amount of from 1 to 200 parts by weight based on 100 parts by weight of said magnetite particles.

27. Magnetic color toner according to claim 26, wherein the amount of the magnetic composite particles in each of the yellow toner, red toner and blue toner is 1 to 25% by weight of the magnetic color toner.

28. Magnetic color toner according to claim 26, wherein said magnetic particles as core particles have a coat which is formed on at least a part of the surface of said magnetic particles as core particles and which comprises at least one compound selected from the group consisting of hydroxides of aluminum, oxides of aluminum, hydroxides of silicon and oxides of silicon in an amount of 0.01 to 20% by weight, calculated as Al or SiO₂, based on the total weight of the magnetic particles coated.

29. A method for developing a magnetic latent image, comprising:
forming a magnetic latent image on surface of an image-retaining member made of a magnetic material;
supplying a developer containing the magnetic toner as defined in claim 23 onto a non-magnetic sleeve disposed opposite to the surface of the image-retaining member made of the magnetic material and provided inside thereof with a magnetic field-generating element to form a magnetic brush on the non-magnetic sleeve; and
bringing the magnetic brush formed on the non-magnetic sleeve into sliding contact with the surface of the image-retaining member to develop the magnetic latent image.

30. A method according to claim 29, wherein an alternating current bias voltage is applied between the magnetic toner and the image-retaining member made of the magnetic material.

31. A method for developing an electrostatic image, comprising:
forming an electrostatic image on surface of a photosensitive member or an electrostatic charge-retaining member;
supplying a developer containing a magnetic carrier and the magnetic toner as defined in claim 23 onto a non-magnetic sleeve disposed opposite to the surface of the photosensitive member or the electrostatic charge-retaining member made of the magnetic material and provided inside thereof with a magnetic field-generating element to form a magnetic brush on the non-magnetic sleeve; and
bringing the magnetic brush formed on the non-magnetic sleeve into sliding contact with the surface of the photosensitive member or the electrostatic charge-retaining member to develop the electrostatic image.

32. A method according to claim 31, wherein an alternating current bias voltage is applied between the magnetic toner and the photosensitive member or the electrostatic charge-retaining member.
